(19) United States
(12) Patent Application Publication
(10) Pub. No.: US 2016/0328705 A1
(43) Pub. Date: Nov. 10, 2016

(54) MEDIATED CONVERSION OF CRYPTOGRAPHIC CURRENCY AND OTHER FUNDING SOURCES TO GOLD

(71) Applicant: BitGold IP Holdings Corp., TORONTO (CA)

(72) Inventors: ROY SEBAG, TORONTO (CA); JOSHUA D. CRUMB, VANCOUVER (CA); ALESSANDRO PREMOLI, MILANO (IT)

(21) Appl. No.: 15/145,861

(22) Filed: May 4, 2016

Related U.S. Application Data
(60) Provisional application No. 62/156,883, filed on May 4, 2015.

(51) Int. Cl. G06Q 20/38; G06Q 20/06

(52) U.S. Cl. CPC G06Q 20/381; G06Q 20/0655; G06Q 2220/00

(57) ABSTRACT

A computer method provides mediated conversion of cryptographic currencies and/or other funding sources to vaulted physical gold a one or more selected vault locations. The computer method can provide services to redeem gold and/or make payment(s) in gold. The computer method can be embodied as computer executable instructions carried by a non-transitory computer readable medium.

### CROSS-REFERENCE TO RELATED APPLICATIONS

The present application claims priority benefit from U.S. Provisional Patent Application No. 62/156,883, entitled “MEDIATED CONVERSION OF CRYPTOGRAPHIC CURRENCY AND OTHER FUNDING SOURCES TO GOLD”, filed May 4, 2015 (docket number 3023-003-02); which, to the extent not inconsistent with the disclosure herein, is incorporated by reference.

### SUMMARY

According to an embodiment, a computer method for converting cryptographic currency to vaulted physical gold includes establishing an authenticated network communication session with a user via data transmissions between a network server and a client device; and reading, from a non-transitory computer readable medium, a user account ledger first balance. The user account ledger can include a cryptographic currency portion and a vaulted gold portion.

The computer method can further include outputting for display on a client device electronic display apparatus, a depiction of at least a portion of the user account ledger first balance; receiving designation of a physical vault location from a plurality of physical vaults; and receiving, from the user via a graphical user interface displayed by the electronic display apparatus of the client device, a gold purchase order command to purchase vaulted gold in the designated vault with a selected cryptographic currency quantity forming at least a portion of the first balance of the cryptographic currency portion of the user account ledger. A server computer then writes, to the user account ledger, a pending transaction corresponding to the user command to purchase vaulted gold; and debits, from the first balance of the cryptographic currency portion of the user account ledger, the selected cryptographic currency quantity to form a user account ledger second balance; and credits the cryptographic currency quantity to an agent ledger balance. The server computer then outputs, for display on the client computer electronic display apparatus, a depiction of the pending transaction and the user account ledger second balance.

The computer method then can purchase or output, to an agent, data indicative of the purchase of the vaulted gold on behalf of the user according to a settlement process using the cryptographic currency quantity credited to the agent. The computer method generates confirmation in an agent computer that the purchased gold has been transferred to the user account. The server computer credits the transferred vaulted gold to the vaulted gold portion of the user ledger balance to form a user account ledger third balance, updates the pending transaction status to a settled status, and outputs for display on the client computer electronic display apparatus a depiction of the settled transaction and the user account ledger third balance.

According to an embodiment, a non-transitory computer readable medium can carry computer instructions configured to cause a computer to execute the steps of the method described above.

### BRIEF DESCRIPTION OF THE DRAWINGS

FIG. 1 is a flow chart depicting a method for converting cryptographic currency to vaulted physical gold, according to an embodiment.

FIG. 2A is a depiction of a graphical user interface (GUI) for making a deposit to a user account via a bank wire, according to an embodiment.

FIG. 2B is a depiction of a GUI for selecting a physical vault location from a plurality of physical vault locations, according to an embodiment

FIG. 2C is a depiction of a GUI for selecting between options for funding a deposit to a designated vault, according to an embodiment.

FIG. 2D is a depiction of a GUI for entering client information for bank wire deposit, according to an embodiment.

FIG. 3A is a depiction of a GUI for making a deposit to the user account via a credit card, according to an embodiment.

FIG. 3B is a depiction of a GUI for selecting a physical vault location from a plurality of physical vault locations, according to an embodiment

FIG. 3C is a depiction of a GUI for selecting between options for funding a deposit to a designated vault, according to an embodiment.

FIG. 3D is a depiction of a GUI for entering a deposit amount and user information, according to an embodiment.

FIG. 3E is a depiction of a display on a client device for acknowledging a transaction, according to an embodiment.

FIG. 4A is a depiction of a GUI for making a deposit to the user account via China Union Pay, according to an embodiment.

FIG. 4B is a depiction of a GUI for selecting a physical vault location from a plurality of physical vault locations, according to an embodiment

FIG. 4C is a depiction of a GUI for selecting between options for funding a deposit to a designated vault, according to an embodiment.

FIG. 4D is a depiction of a GUI for entering a deposit amount and user information, according to an embodiment.

FIG. 4E is a depiction of a display on a client device for acknowledging a transaction, according to an embodiment.

FIG. 5A is a depiction of a GUI for making a deposit to the user account via Interac, according to an embodiment.

FIG. 5B is a depiction of a GUI for selecting a physical vault from a plurality of physical vault locations, according to an embodiment

FIG. 5C is a depiction of a GUI for selecting between options for funding a deposit to a designated vault, according to an embodiment.

FIG. 5D is a depiction of a GUI for entering deposit amount and user information, according to an embodiment.

FIG. 5E is a depiction of a display on a client device for acknowledging a transaction, according to an embodiment.

FIG. 6A is a depiction of a GUI for making a deposit to the user account via Bitcoin, according to an embodiment.

FIG. 6B is a depiction of a GUI for selecting a physical vault from a plurality of physical vault locations, according to an embodiment

FIG. 6C is a depiction of a GUI for selecting between options for funding a deposit to a designated vault, according to an embodiment.

FIG. 6D is a depiction of a GUI for entering deposit amount and user information, according to an embodiment.

FIG. 6E is a depiction of a display on a client device for acknowledging a transaction, according to an embodiment.

FIG. 7A is a depiction of a GUI for redeeming gold from a user account via Bank Wire, according to an embodiment.

FIG. 7B is a depiction of a GUI for selecting between options for redeeming funds, according to an embodiment.

FIG. 7C is a depiction of a GUI for entering user information, according to an embodiment.

FIG. 7D is a depiction of a display on a client device for acknowledging a transaction, according to an embodiment.

FIG. 8A is depiction of a GUI for redeeming funds from a user account via Credit Card, according to an embodiment.

FIG. 8B is a depiction of a GUI for selecting between options for redeeming funds, according to an embodiment.

FIG. 8C is a depiction of a GUI for selecting a physical vault from a plurality of physical vault locations, according to an embodiment.

FIG. 8D is a depiction of a GUI notice including information for redeeming funds via Credit Card, according to an embodiment.

FIG. 8E is a depiction of a display on a client device for acknowledging a transaction, according to an embodiment.

FIG. 8F is a depiction of a display on a client device for providing a transaction summary, according to an embodiment.

FIG. 9A is a depiction of a GUI for redeeming funds from a user account via physical gold, according to an embodiment.

FIG. 9B is a depiction of a GUI for selecting between options for redeeming funds, according to an embodiment.

FIG. 9C is a depiction of a GUI for selecting a physical vault from a plurality of physical vault locations, according to an embodiment.

FIG. 9D is a depiction of a GUI for selecting physical gold type, according to an embodiment.

FIG. 9E is a depiction of a display on a client device for completing a transaction, according to an embodiment.

FIG. 10 is a depiction of a GUI displaying the user account overview, according to an embodiment.

FIG. 11 is a depiction of a GUI displaying the user account transaction history, according to an embodiment.

FIG. 12 is a depiction of a GUI for sending a payment, according to an embodiment.

FIG. 13 is a depiction of a GUI for sending an invoice, according to an embodiment.

FIG. 14 is a depiction of a GUI for the user account contacts, according to an embodiment.

FIG. 15 is a depiction of a GUI for viewing the Service Provider Debit Card, according to an embodiment.

FIG. 16 is a depiction of a GUI for viewing statements, according to an embodiment.

FIG. 17 is a depiction of a GUI for changing account profile information, according to an embodiment.

FIG. 18 is a depiction of a GUI for changing a user password, according to an embodiment.

FIG. 19 is a depiction of a GUI for changing account settings, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

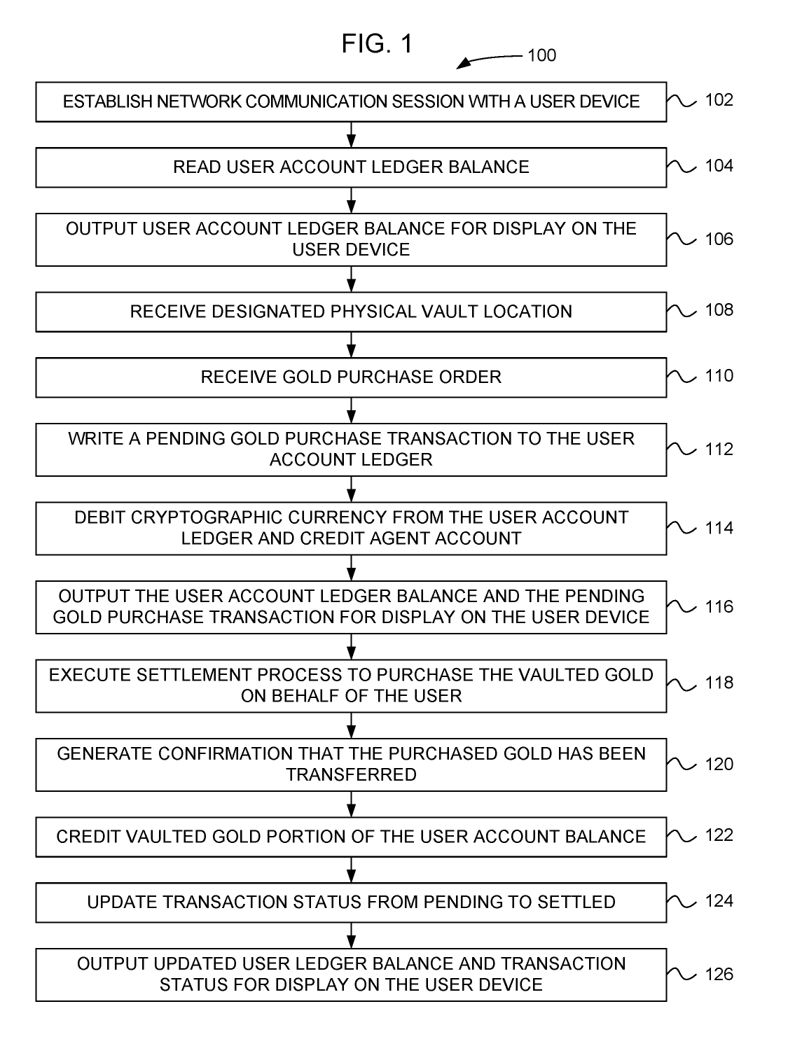

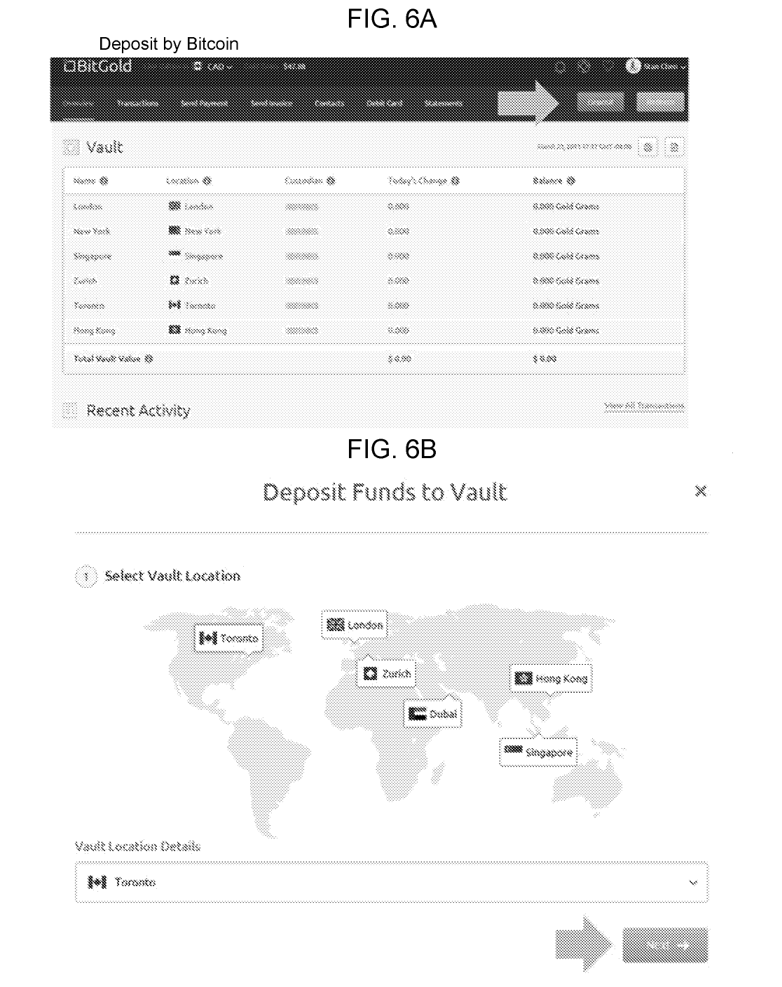

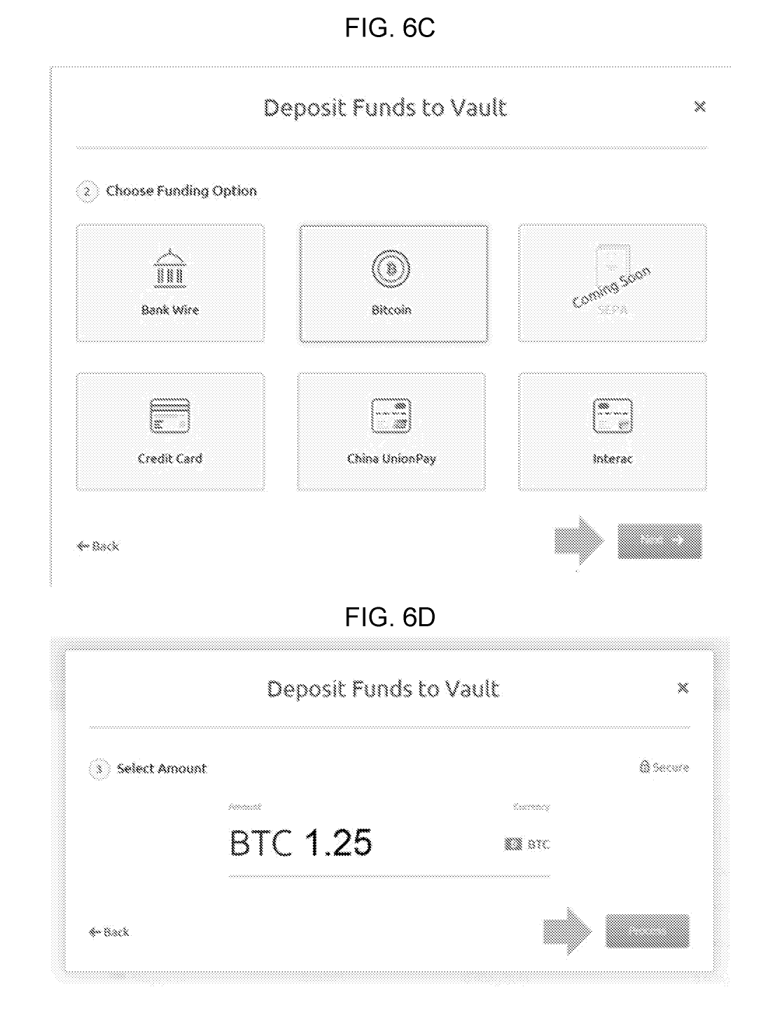

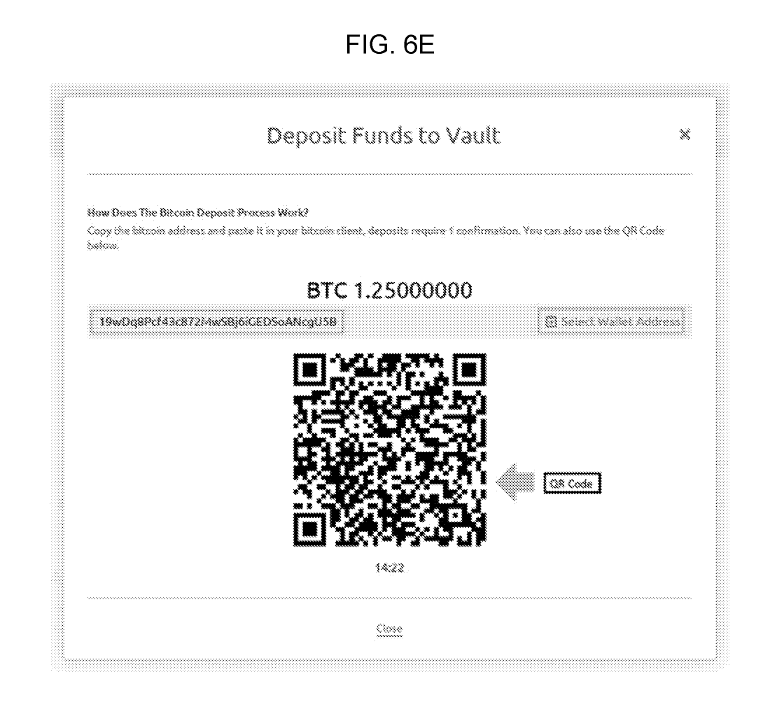

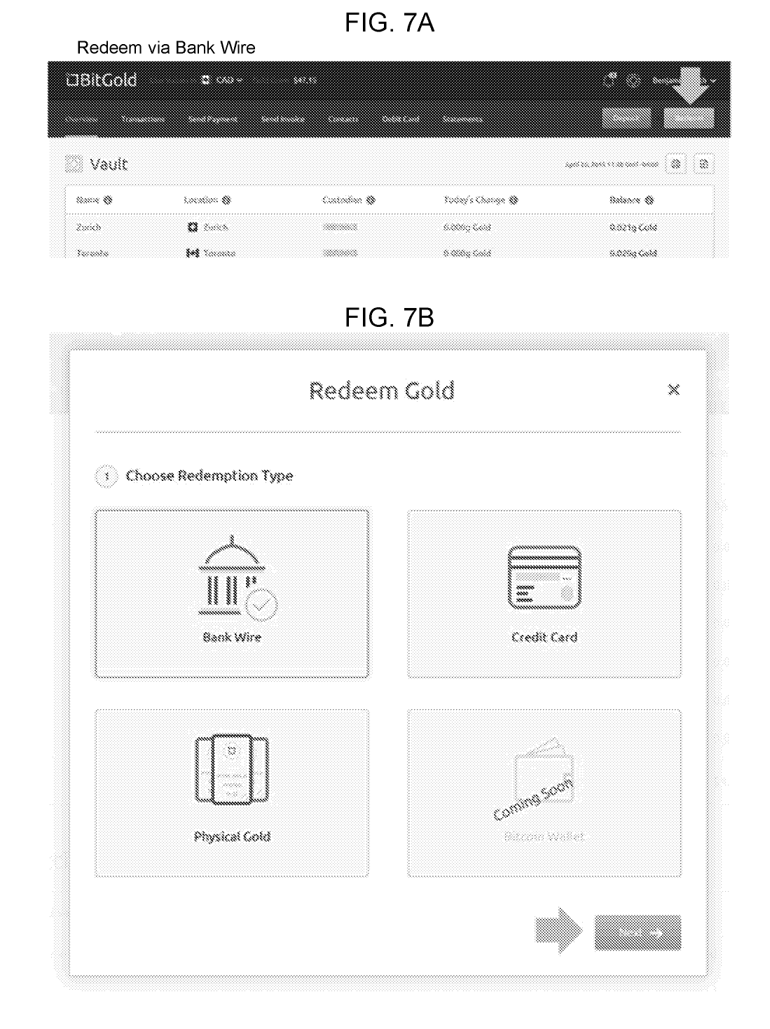

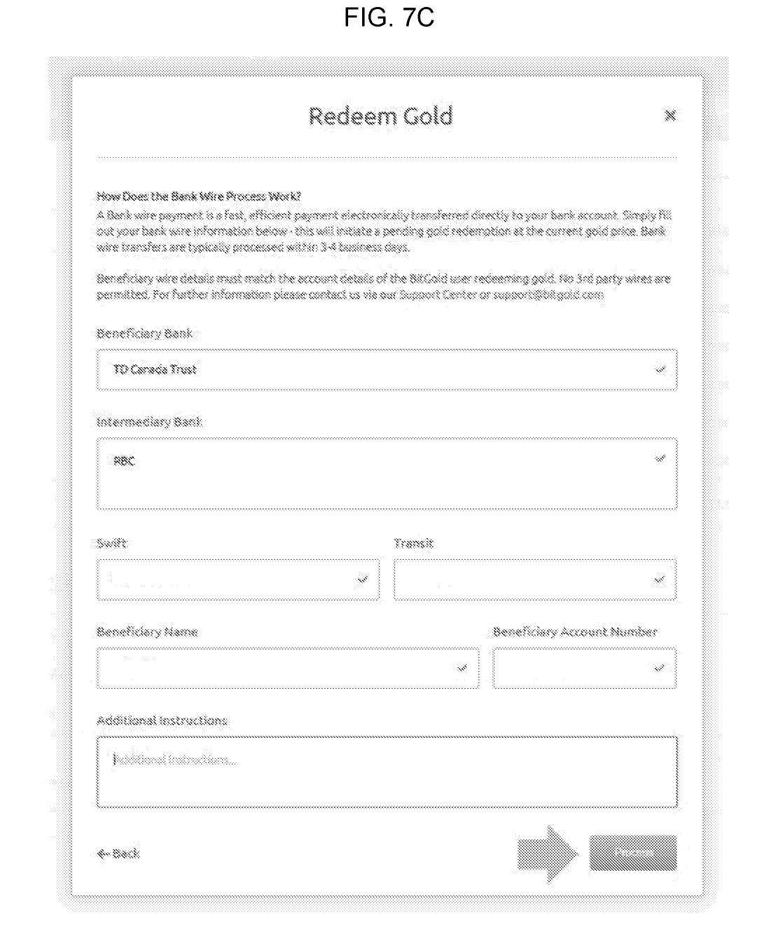

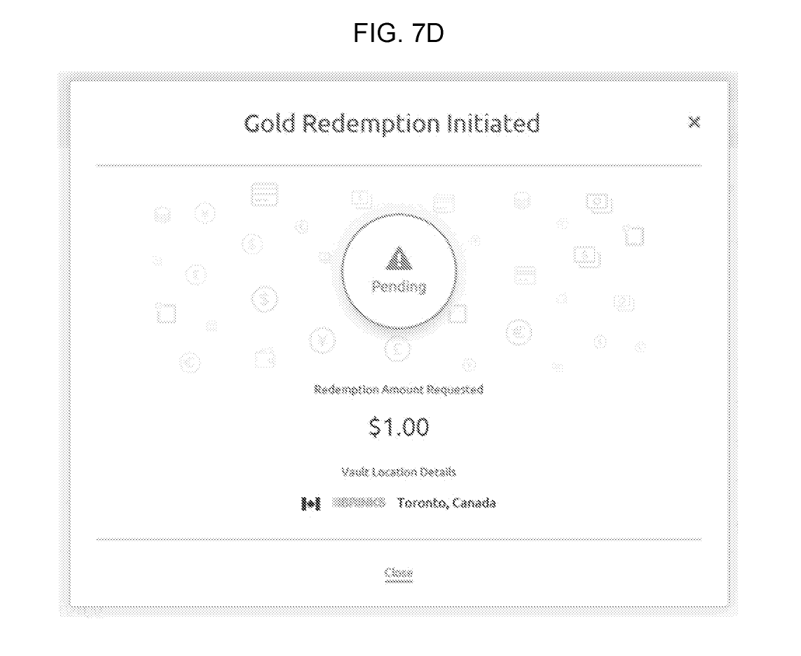

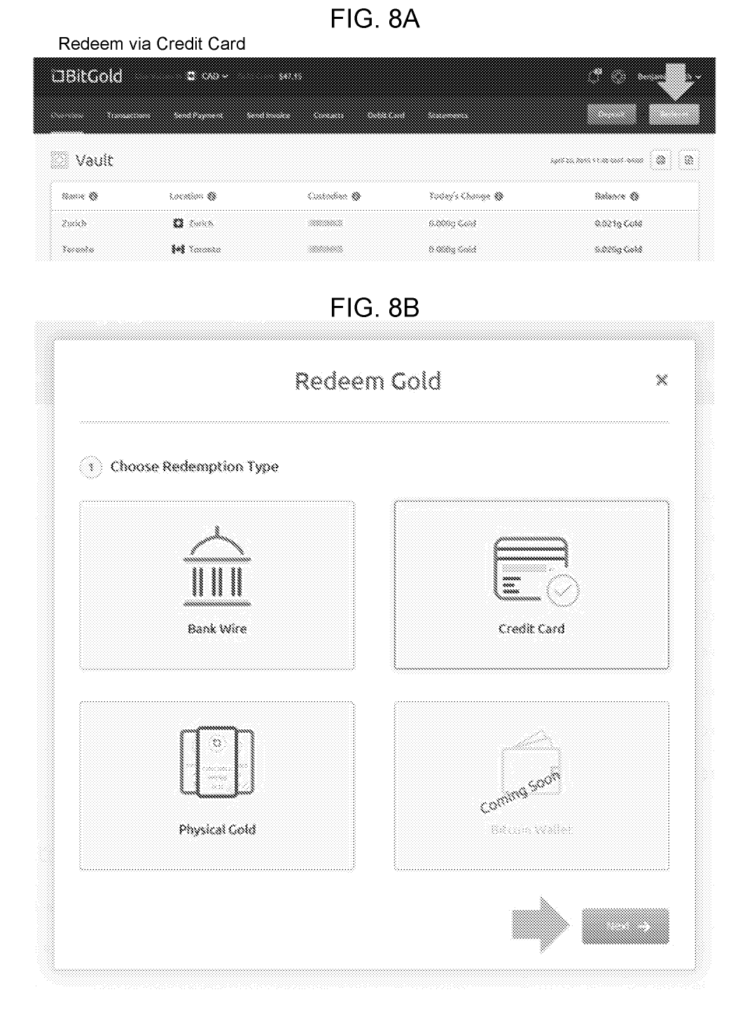

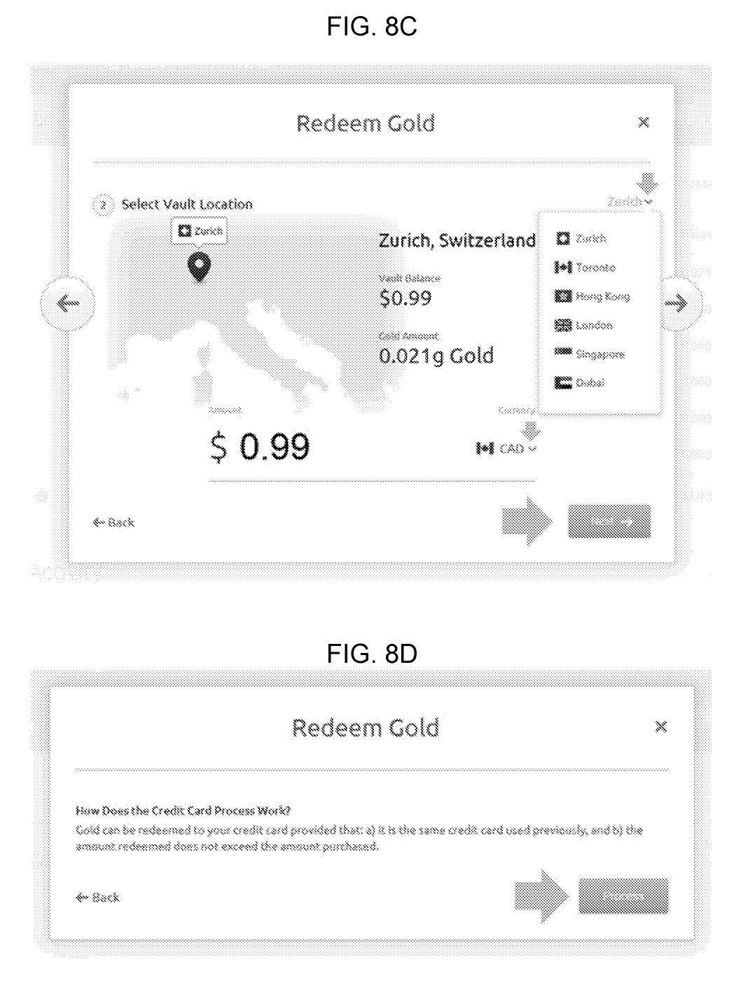

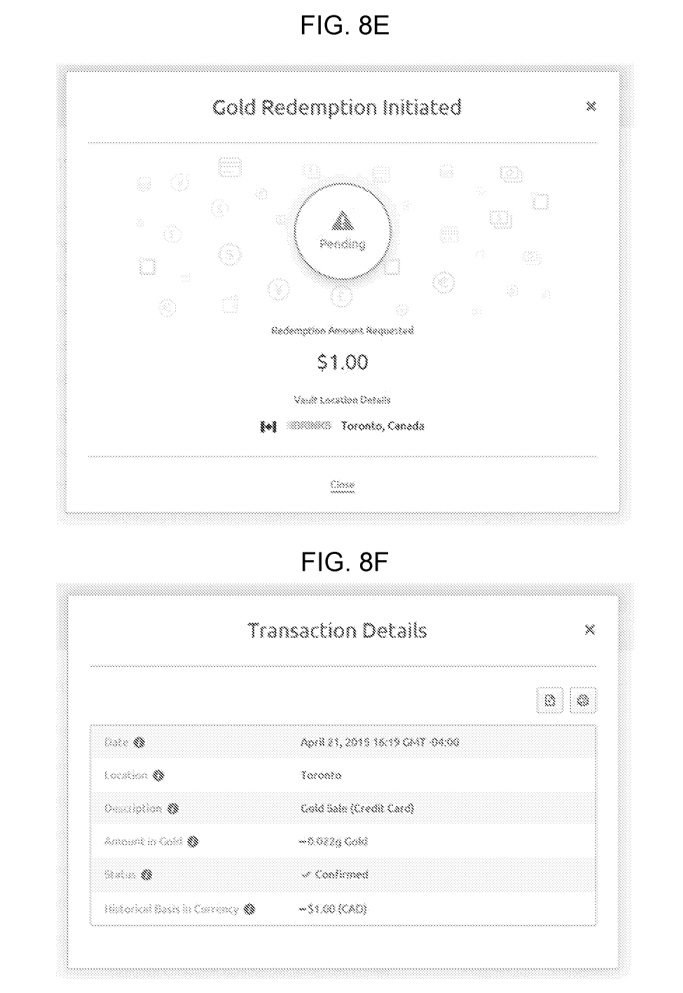

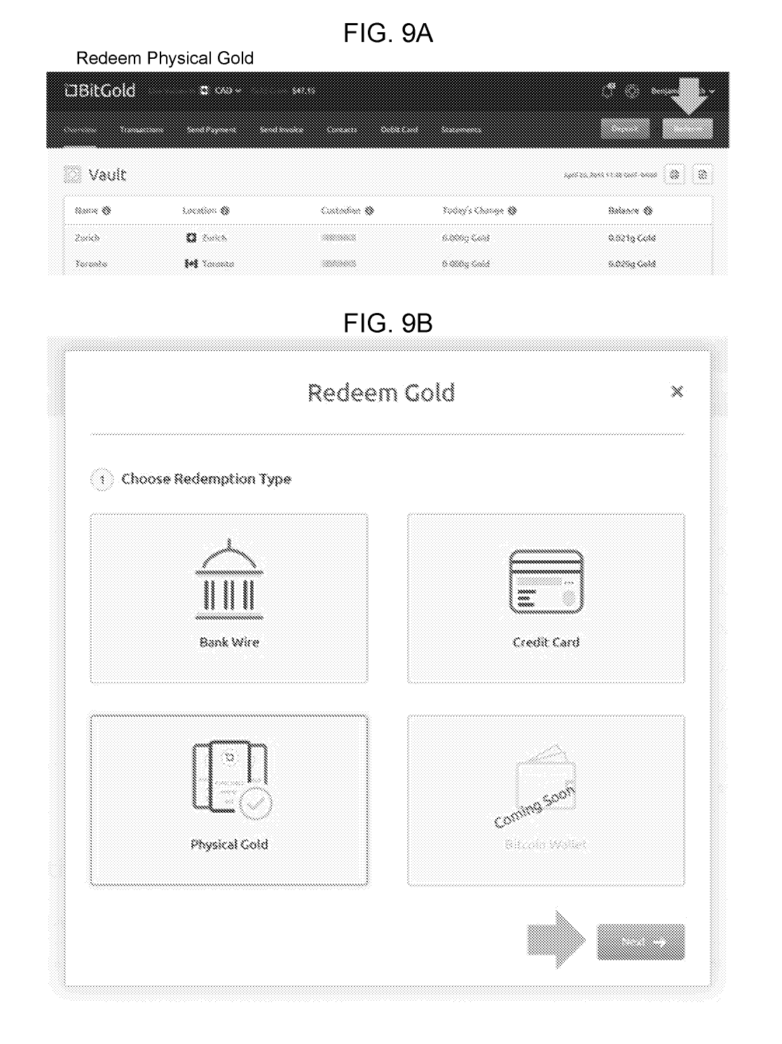

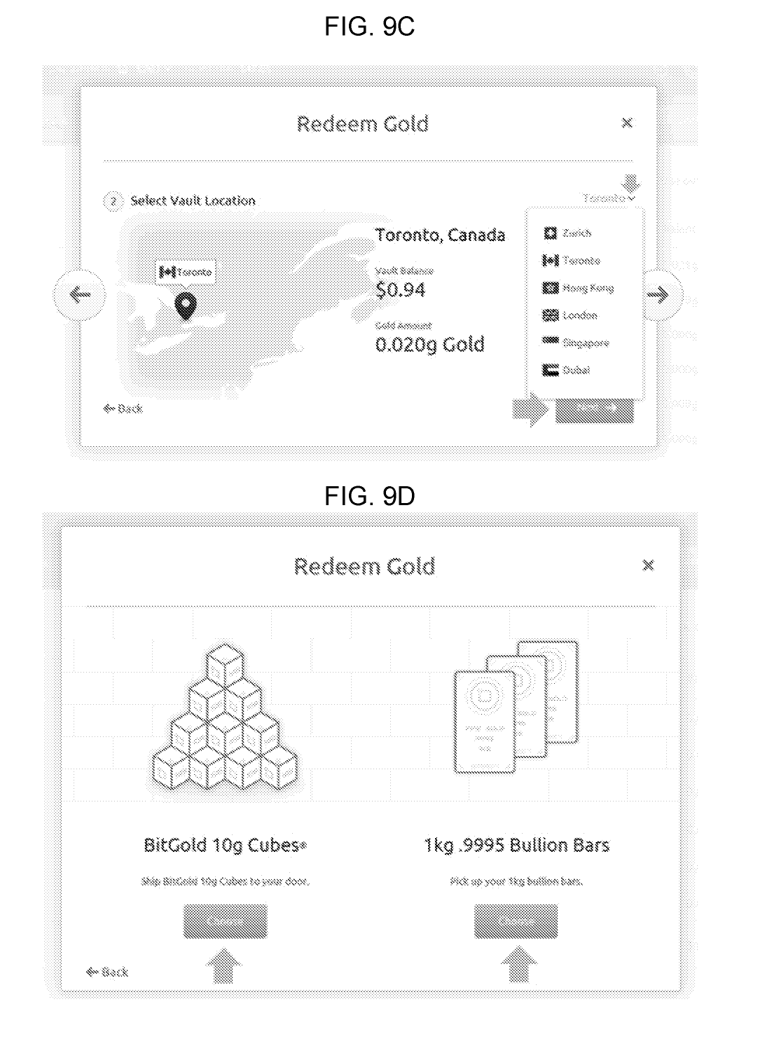

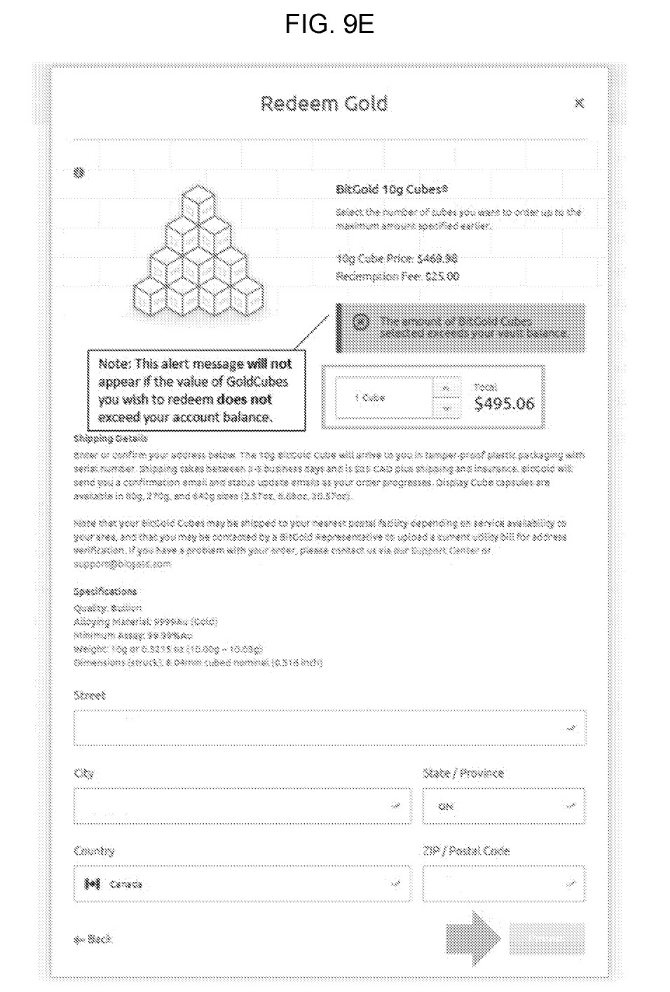

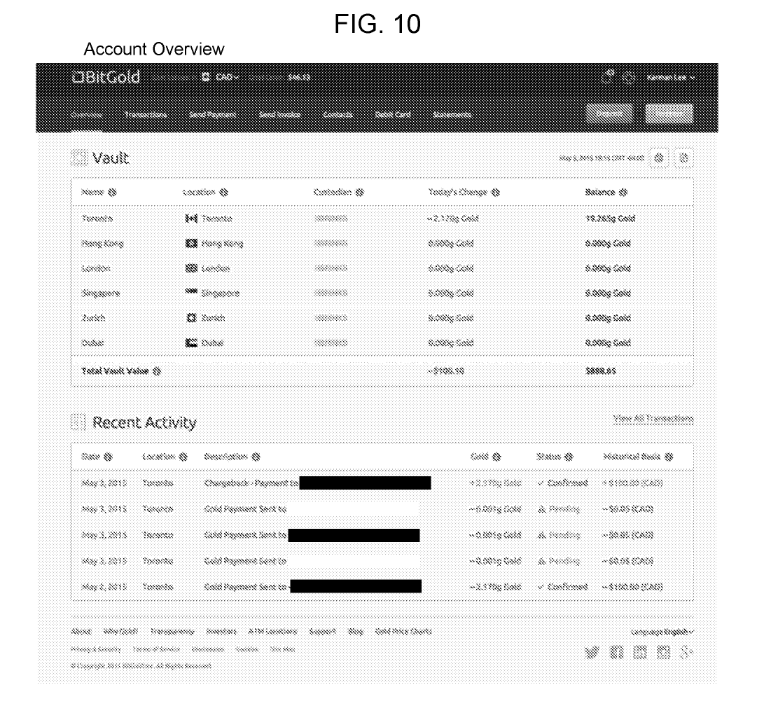

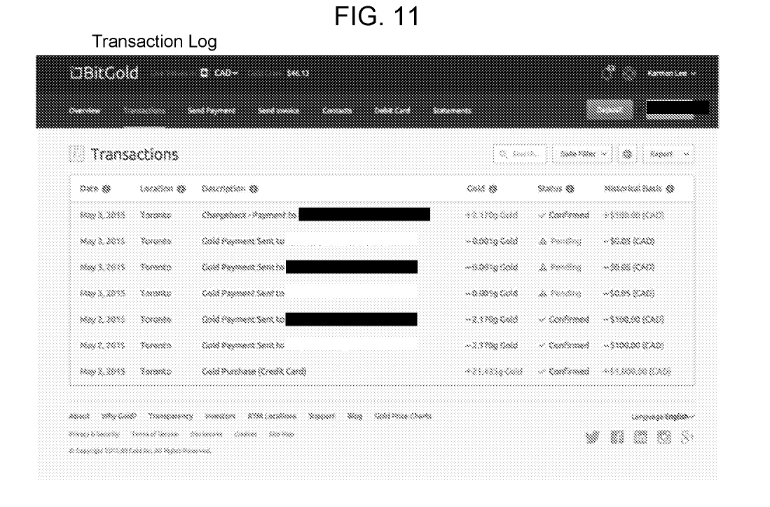

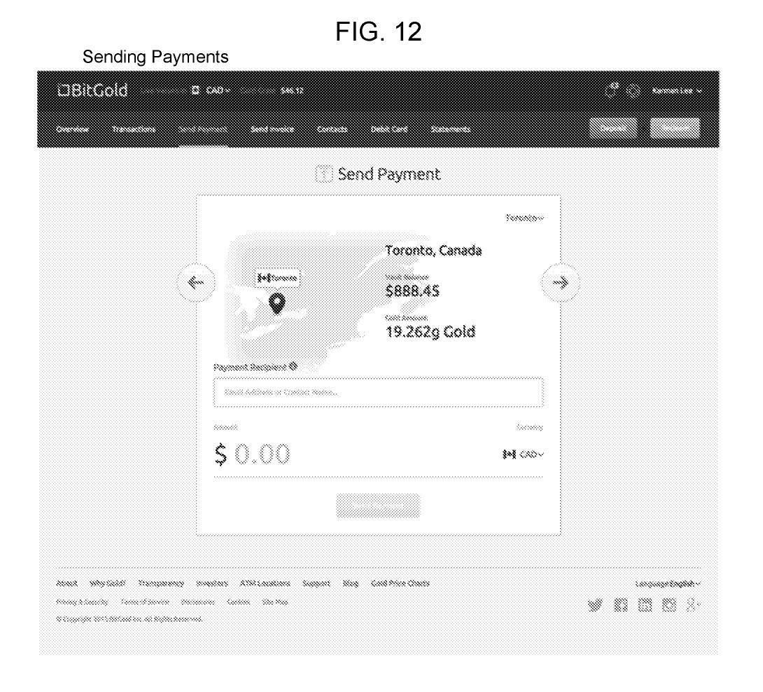

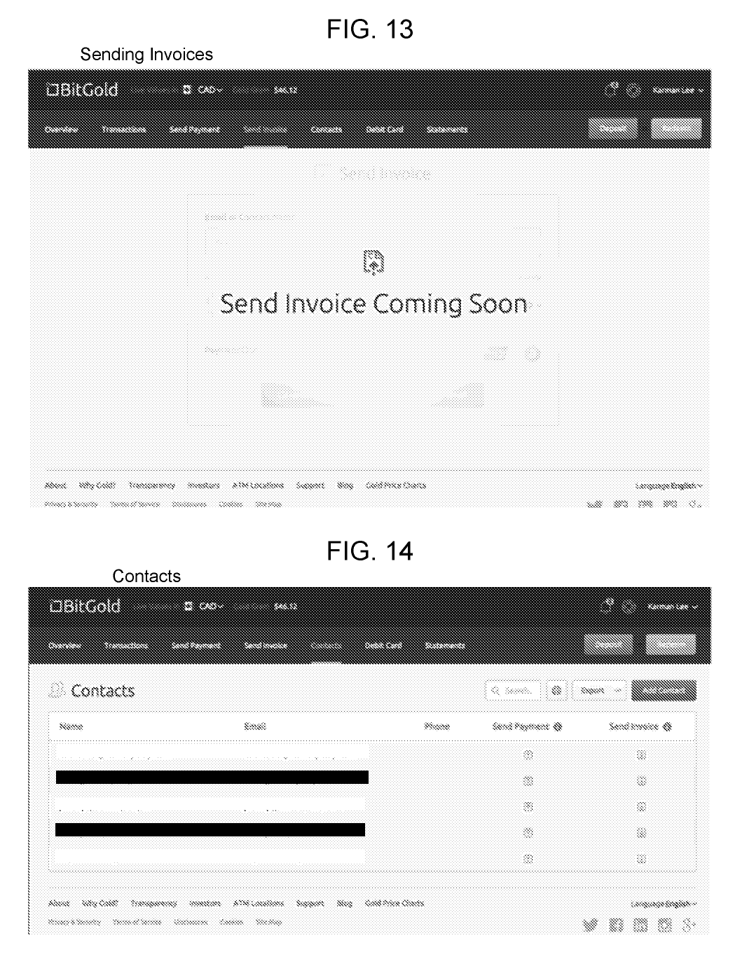

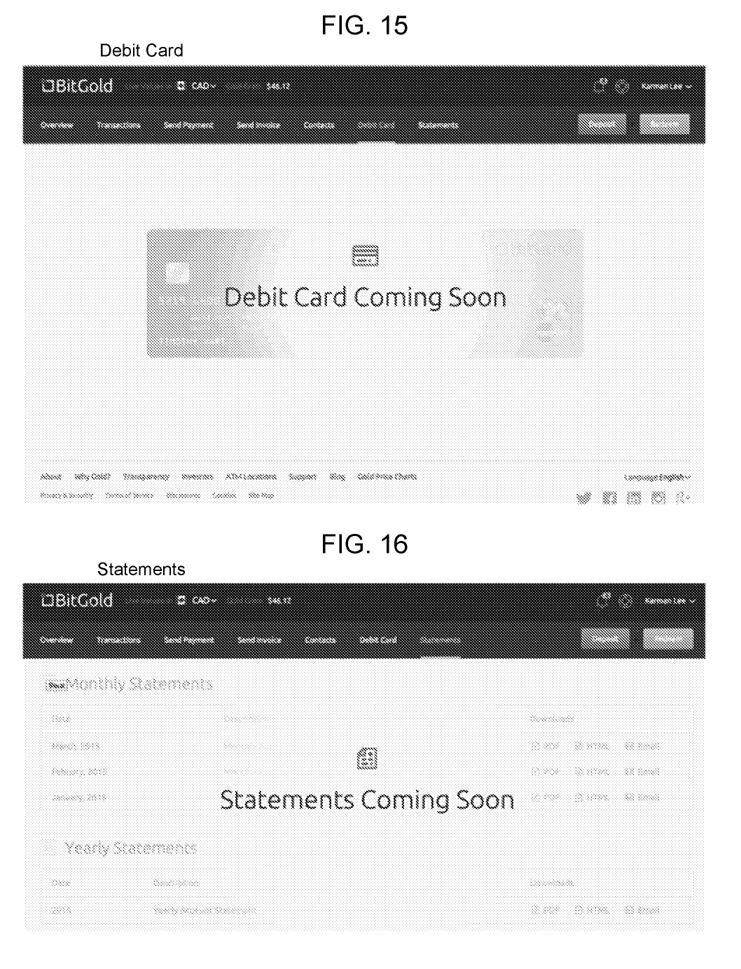

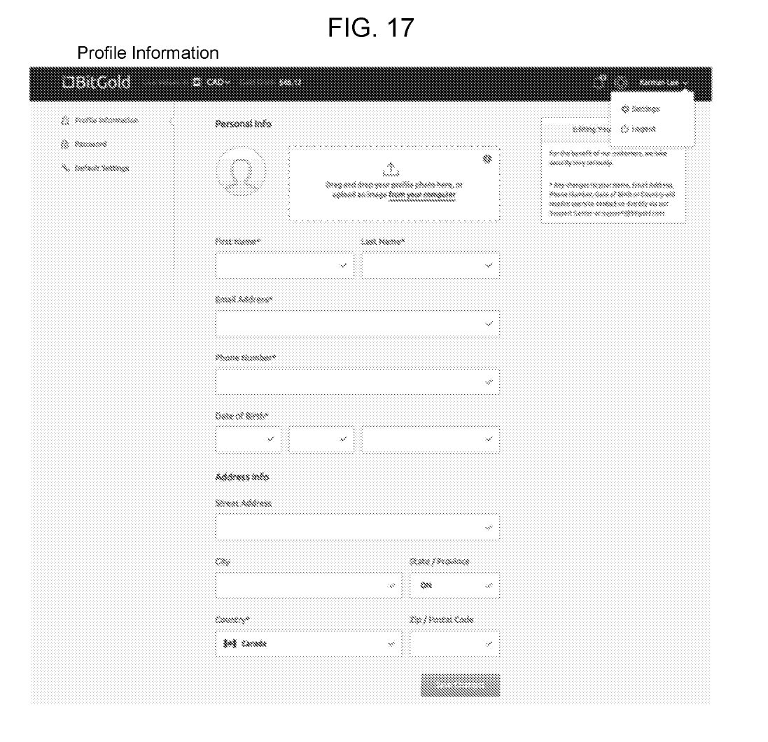

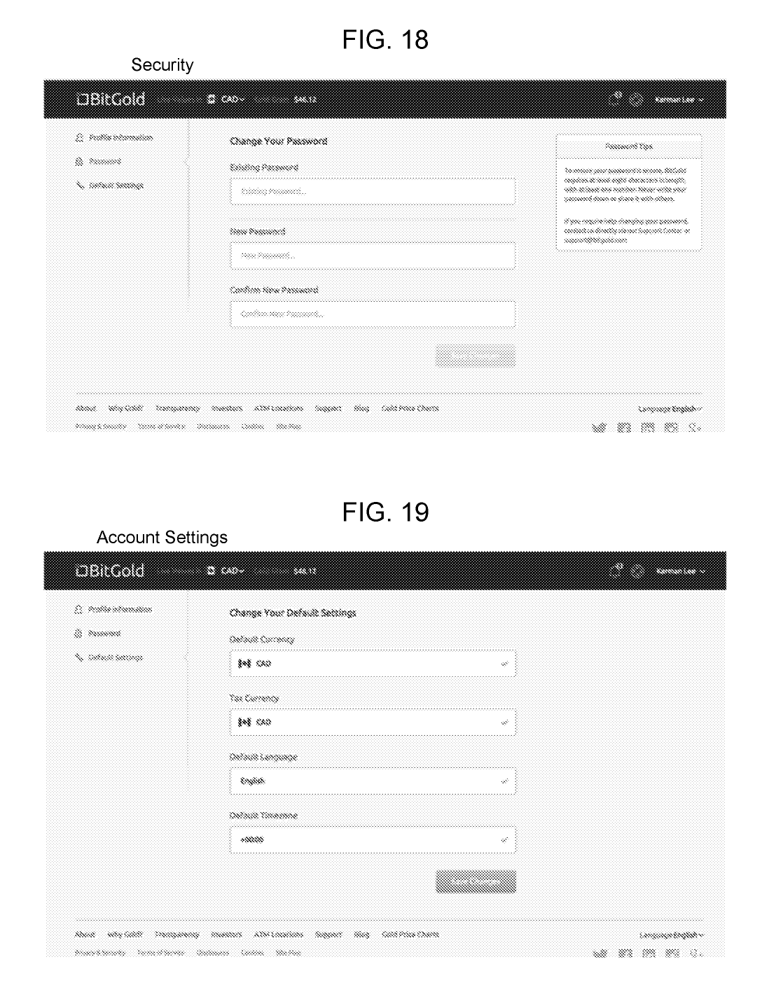

FIG. 1 is a flowchart showing a computer method 100 for converting cryptographic currency to vaulted physical gold, according to an embodiment. Beginning with step 102, a networked server computer establishes an authenticated network communication session with a user via data transmissions between a network server and a client device. Proceeding to step 104, the server computer reads, from a non-transitory computer readable medium, a user account ledger first balance, the user account ledger including a cryptographic currency portion and a vaulted gold portion. For example, FIG. 6A illustrates a depiction of a vaulted gold portion of the user account ledger balance.

Proceeding to step 106, the server computer outputs, for display on a client device electronic display apparatus, a depiction of at least a portion of the user account ledger first balance. In this description, the first balance refers to respective amounts of cryptographic currency and physical vaulted gold present at the beginning of the transaction described herein.

The server computer can further cause the client device to display a graphical user interface (GUI) that shows a plurality of gold vaulting locations in which the user may purchase physical gold (e.g., see FIG. 6B). Proceeding to step 108, the server computer receives, via the GUI displayed on the client device, a designation of a physical vault location from the plurality of physical vaults. FIG. 6B illustrates “Toronto” as being selected.

The inventors contemplate several alternatives to receiving designation of a physical vault location by receiving a physical vault selection from the user via the graphical user interface displayed by the electronic display apparatus of the client device depicted in FIG. 6B. In one embodiment, receiving designation of a physical vault location includes receiving a client device location from a client device location services module and designating a physical vault having a location corresponding to the client device location. In another embodiment, receiving designation of a physical vault location can include reading a user residence location from a user profile (e.g., carried by a non-transitory computer-readable medium) and designating a physical vault having a location corresponding to the user residence location. In another embodiment, receiving designation of a physical vault location can include reading metadata corresponding to a data transmission from the client device, the metadata including one or more network server identities through which the data transmission was relayed; inferring a client device location from the network server identities; and designating a physical vault having a location corresponding to the inferred client device location.

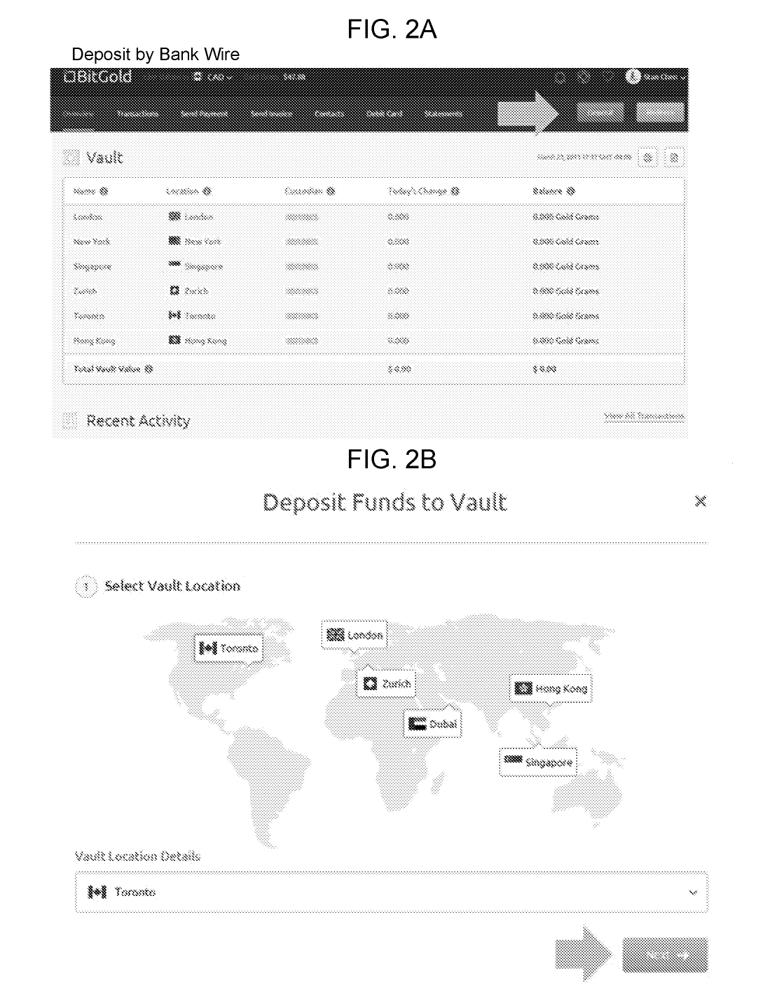

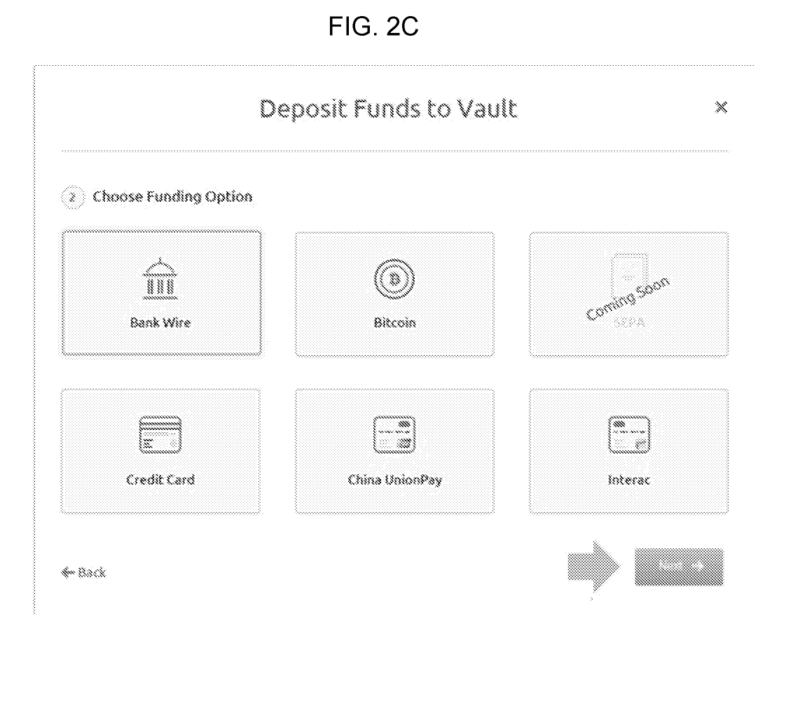

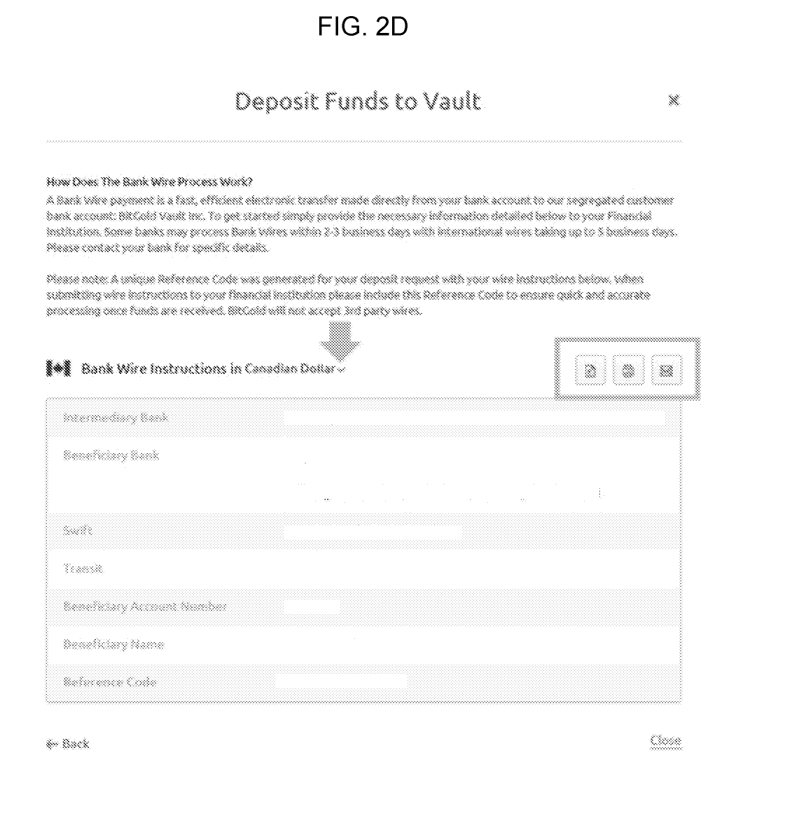

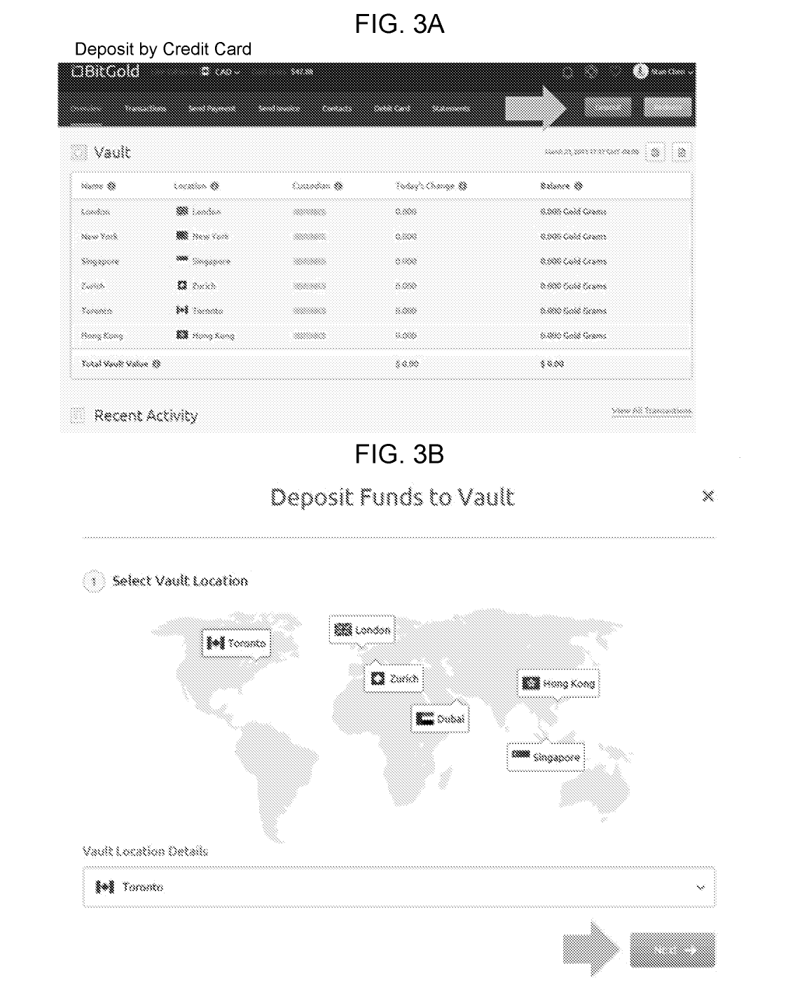

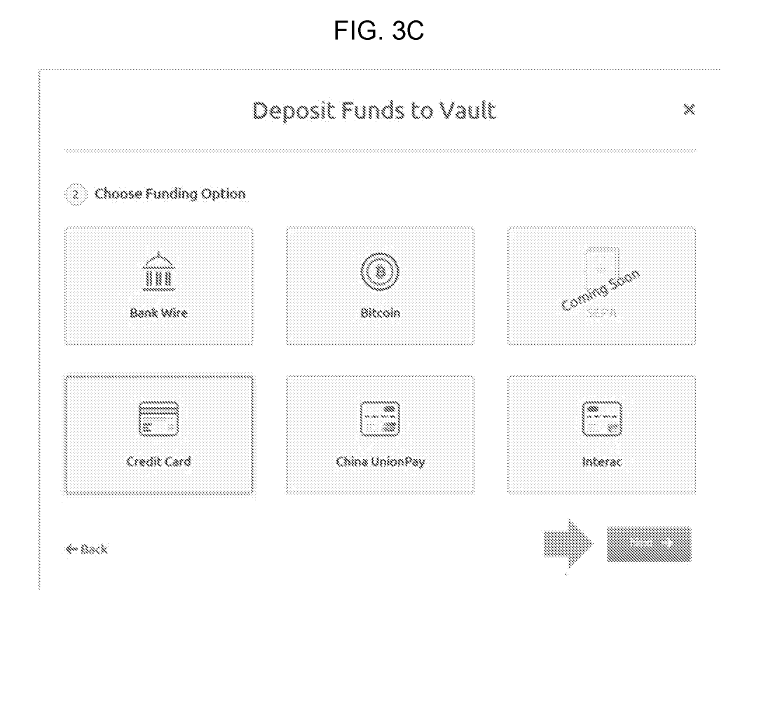

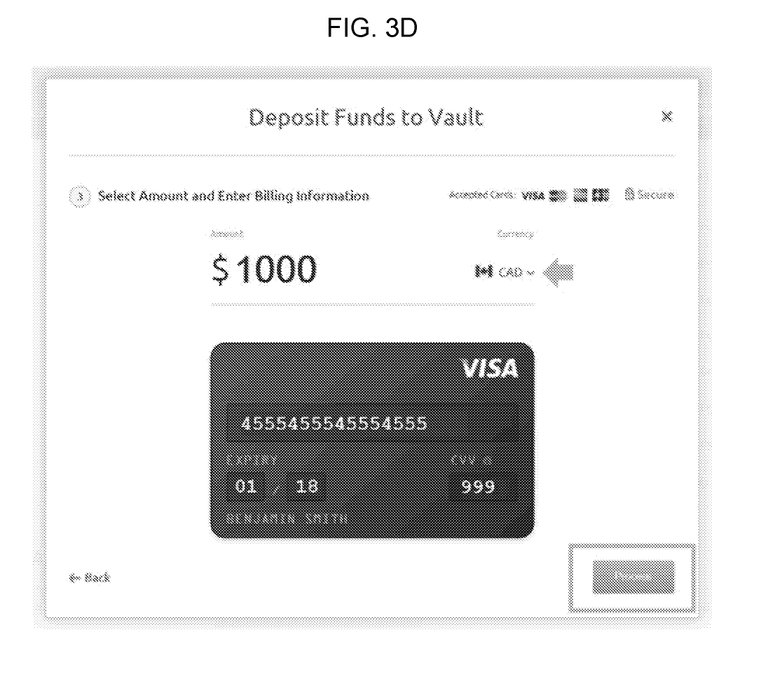

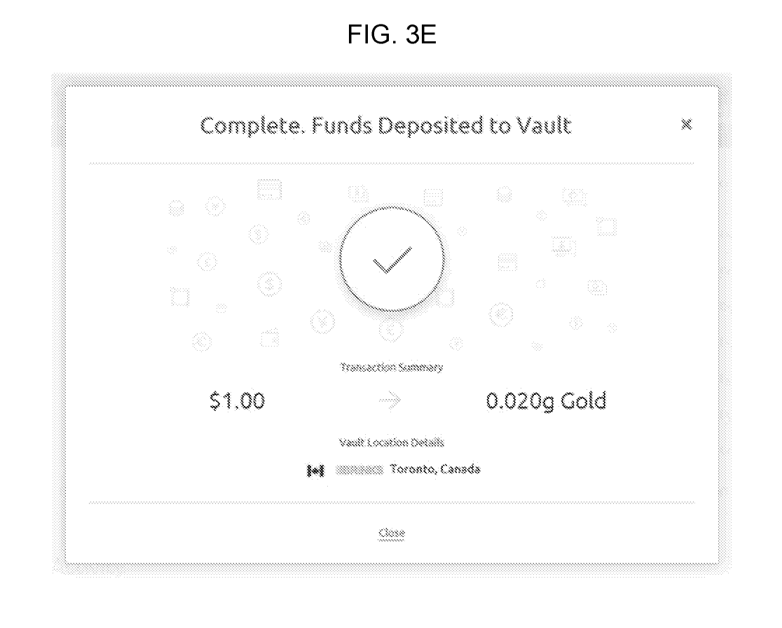

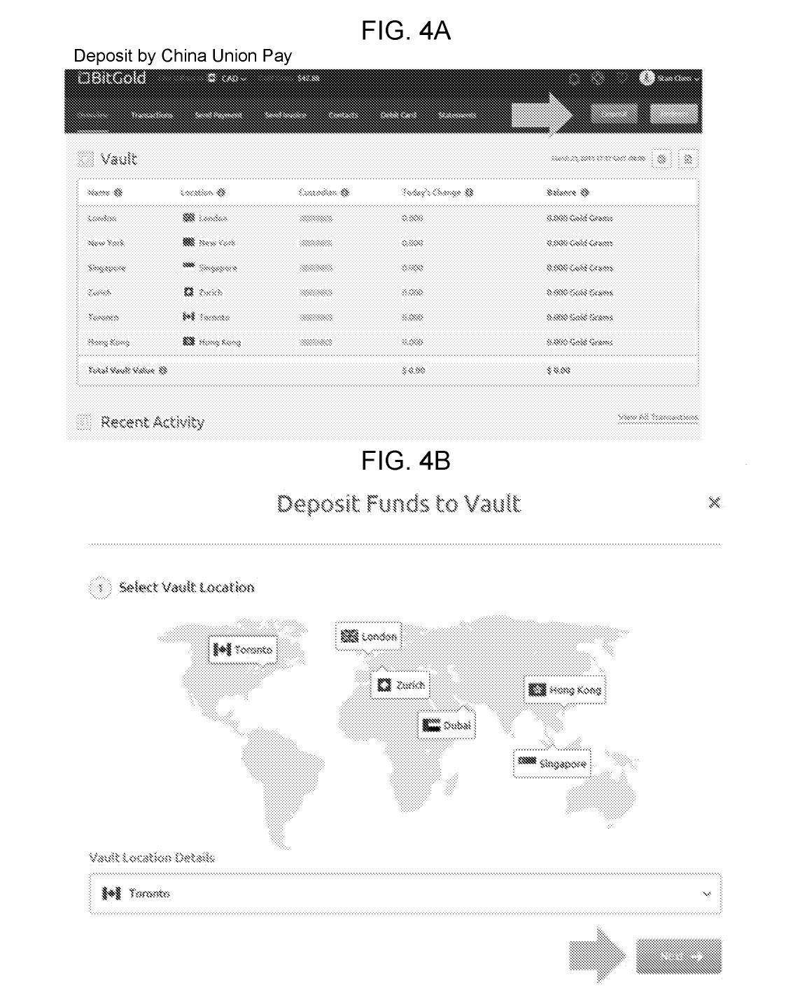

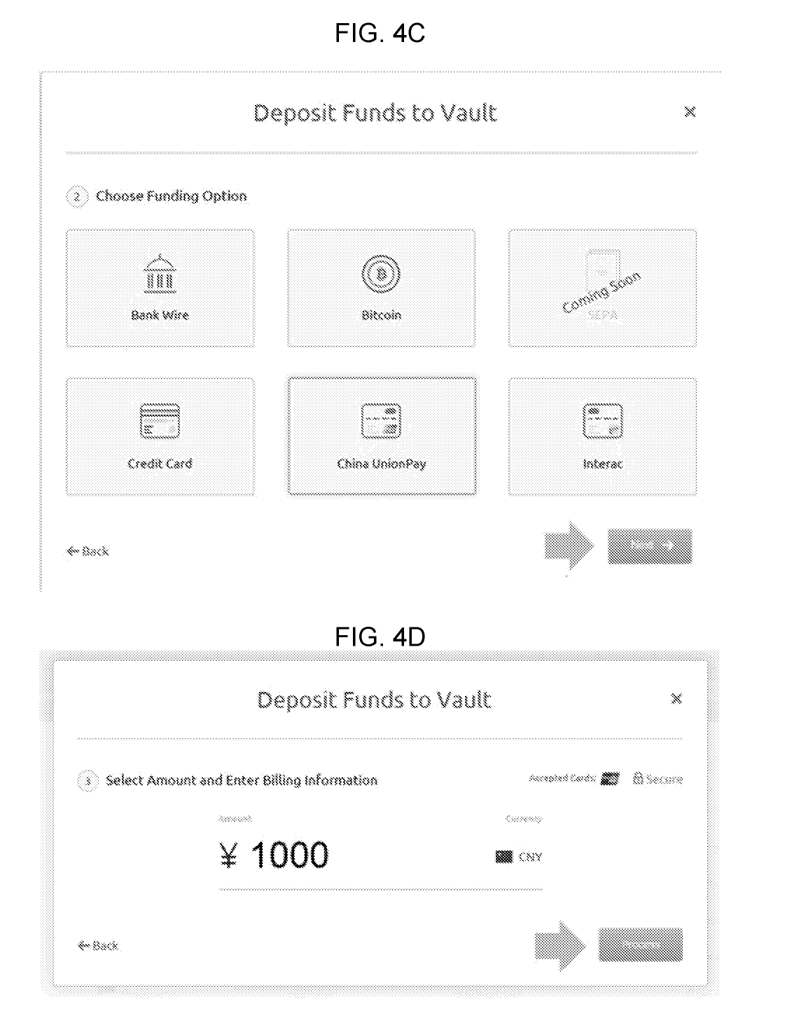

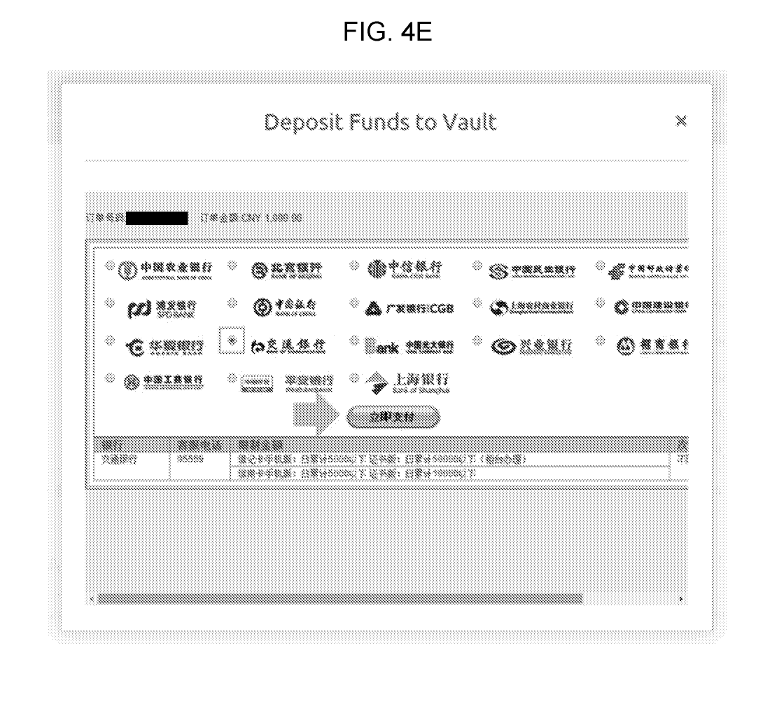

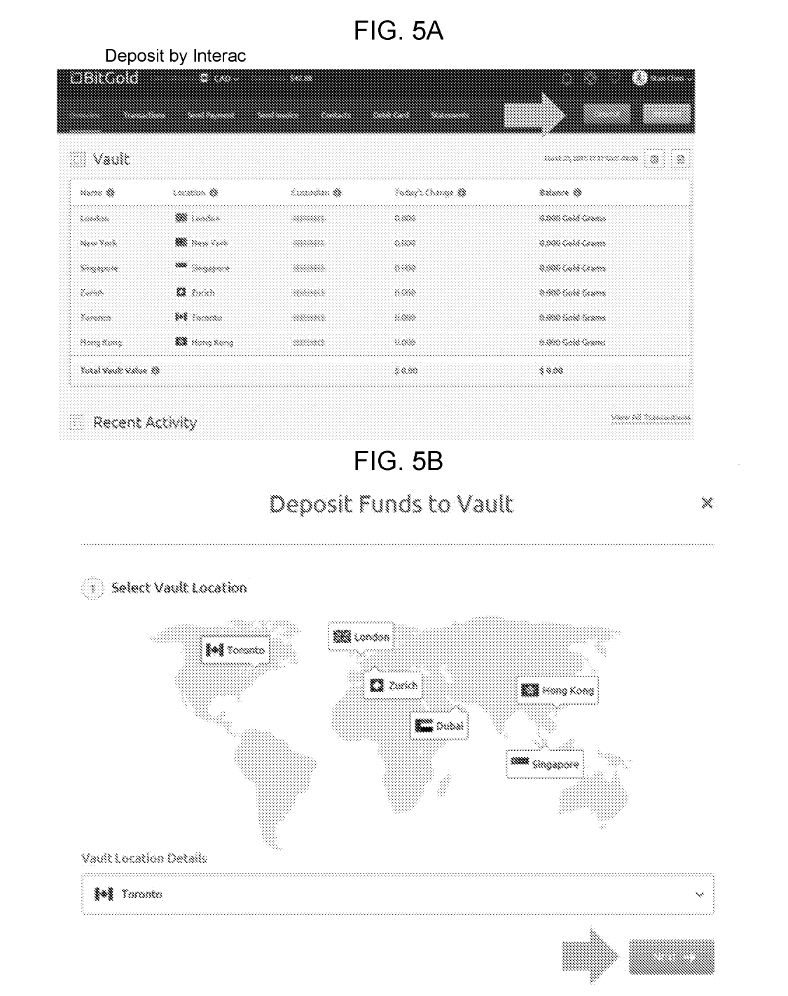

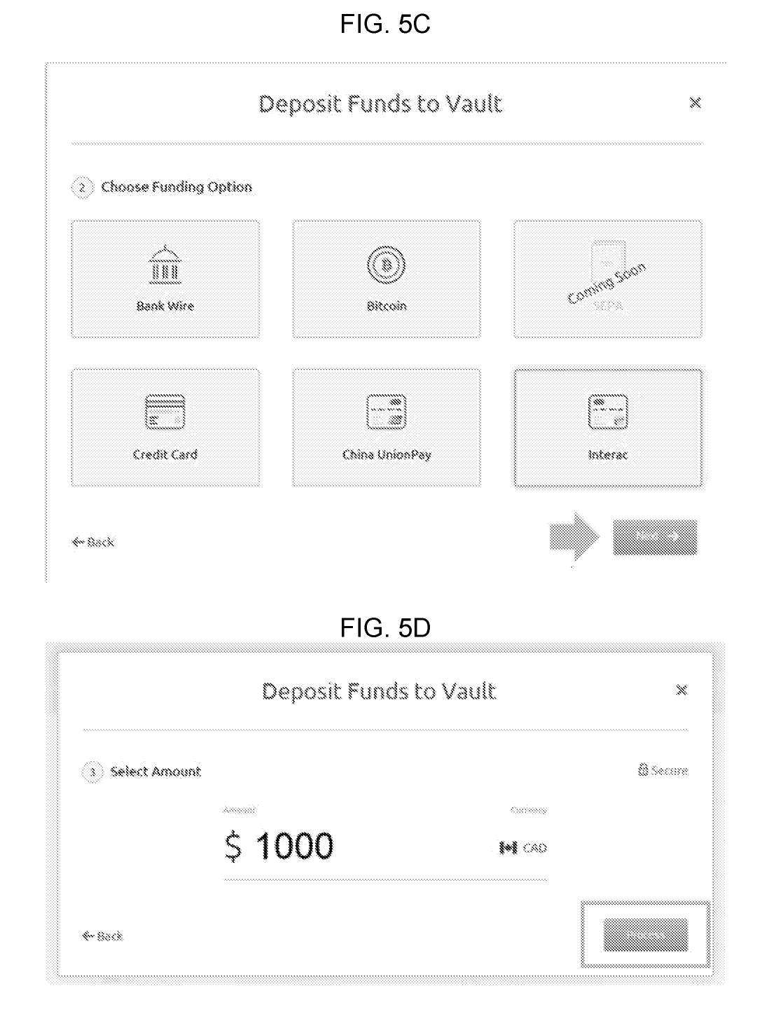

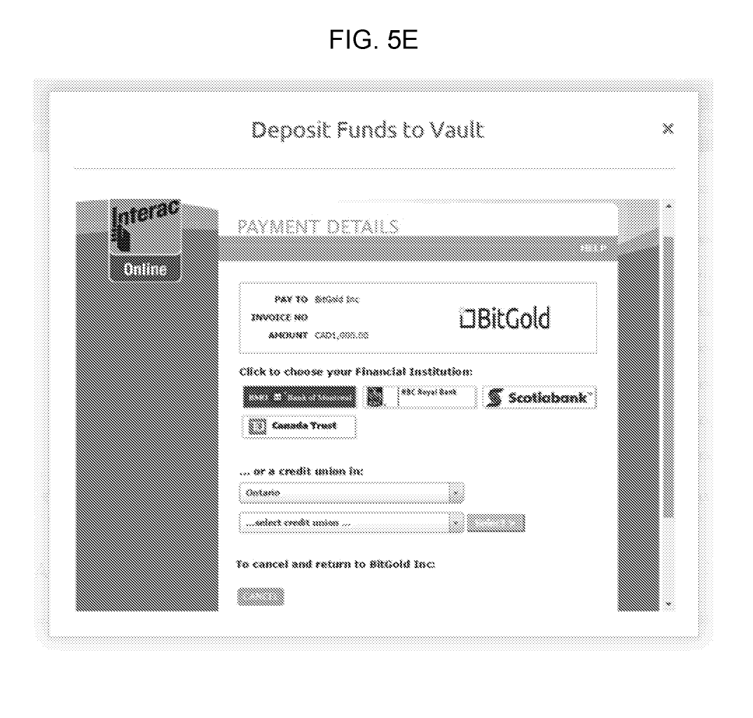

Optionally, the method 100 can offer a plurality of funding options for purchasing the physical vaulted gold. As shown variously in FIGS. 2C, 3C, 4C, 5C, and 6C, the server computer can cause display of a GUI for the user to select funding respectively by bank wire, via a credit card, from a debit account such as “China UnionPay”, from “Interac”, or from a cryptographic currency wallet such as a “Bitcoin” wallet. For economy of language, the description below generally focuses on funding from a cryptographic currency wallet.

Proceeding to step 110, the server computer receives, from the user via a graphical user interface displayed by the electronic display apparatus of the client device, a gold purchase order command to purchase vaulted gold in the designated vault with a selected cryptographic currency quantity forming at least a portion of the first balance of the cryptographic currency portion of the user account ledger. FIG. 6D illustrates a GUI for receiving a cryptographic currency amount to be used for purchasing gold in the designated vault. The “Process” button portion of the GUI of FIG. 6D provides an object for enabling the user to issue the gold purchase order command. FIG. 6E illustrates a client device display of a cryptographic currency wallet address, both in human readable form and encoded in a QR Code 2D matrix machine-readable symbol.

Upon receipt of the gold purchase order, the server computer can write, in step 112, a pending transaction corresponding to the user command to purchase vaulted gold to the user account ledger.

Proceeding to step 114, the server computer can debit, from the first balance of the cryptographic currency portion of the user account ledger, the selected cryptographic currency quantity to form a user account ledger second balance. Also in step 114, the server computer can credit the cryptographic currency quantity to an agent ledger balance. In step 116, the server computer can output, for display on the client computer electronic display apparatus, a depiction of the pending transaction and the user account ledger second balance.

Proceeding to process step 118, the system can cause the purchase of the vaulted gold on behalf of the user according to a settlement process using the cryptographic currency quantity credited to the agent. The inventors contemplate various approaches for embodying the settlement process.

For example, the settlement process 118 can include displaying the gold purchase order on an electronic display of an agent device and receiving, from the agent via a user interface of the agent device, an order to purchase the vaulted gold from a seller of the vaulted gold. Additionally or alternatively, the settlement process 118 can be executed automatically by a computer executing computer executable instructions carried on a non-transitory computer readable medium.

In an embodiment, the settlement process 118 includes aggregating a plurality of user gold purchase orders. For example, the settlement process 118 can include aggregating a plurality of gold purchase order commands from a plurality of users to purchase vaulted gold in the designated vault, determining when the aggregated gold purchase order commands correspond to a minimum gold purchase quantity at the designated vault, causing a payment of an aggregated amount of cryptographic currency to a gold seller in return for aggregated gold purchase quantity at the designated vault, and receiving confirmation from the designated vault that the aggregated purchased gold has been transferred from the gold seller.

In another example, the settlement process 118 can include aggregating a plurality of gold purchase order commands from a plurality of users to purchase vaulted gold in the designated vault, determining when the aggregated gold purchase order commands correspond to a minimum gold purchase quantity at the designated vault, causing a conversion of the corresponding aggregated amounts into an aggregated amount of fiat currency, causing a payment of the aggregated amount of fiat currency to a gold seller in return for aggregated gold purchase quantity at the designated vault, and receiving confirmation from the designated vault that the aggregated purchased gold has been transferred from the gold seller.

In another example, the settlement process 118 can include aggregating a plurality of gold purchase order commands from a plurality of users to purchase vaulted gold in the designated vault, determining when the aggregated gold purchase order commands correspond to a minimum gold purchase quantity at the designated vault, causing a conversion of the corresponding aggregated cryptographic currency amounts into an aggregated amount of fiat currency, causing a payment of the aggregated amount of fiat currency to a gold seller in return for aggregated gold purchase quantity at the designated vault, and receiving confirmation from the designated vault that the aggregated purchased gold has been transferred from the gold seller.

Proceeding to step 120, the server computer can generate confirmation in an agent computer that the purchased gold has been transferred to the user account. For example, generating confirmation that the purchased gold has been transferred to the user account can includes apportioning a confirmed aggregated gold purchase confirmation to the user.

In step 122, the server computer can credit the transferred vaulted gold to the vaulted gold portion of the user ledger balance to form a user account ledger third balance. In an embodiment, crediting the transferred vaulted gold to the vaulted gold portion of the user ledger balance includes crediting an apportioned amount of the transferred vaulted gold portion of the aggregated purchase corresponding to the vaulted gold portion of the user ledger balance.

In step 124, the server computer can update the pending transaction status to a settled status; and, in step 126, output for display on the client computer electronic display apparatus a depiction of the settled transaction and the user account ledger third balance.

In an embodiment, the purchased gold corresponds to an integer number of gold units. For example the agent may either combine individual user gold purchase orders to equal the value of the integer number of gold units, may provide additional agent funds to complete an integer number of gold units purchase, or may itself provide a gold unit to complete an underfunded aggregated gold purchase. For example, the agent (and optionally, the server computer) can add to the aggregated amount of fiat currency an additional amount of fiat currency sufficient to cause purchase of the integer number of gold units. Additionally or alternatively, the agent and/or the server computer can add to the aggregated amount of cryptographic currency an additional amount of cryptographic currency sufficient to cause purchase of the integer number of gold units. Additionally or alternatively, the agent and/or the server computer can add to the aggregated amount of purchased gold, an additional amount of gold credits sufficient to cause purchase of the integer number of gold units.

In an embodiment, the method 100 further includes determining a gold price and outputting the gold price for display to the user on the client device.

The method 100 described in conjunction with FIG. 1 may be embodied in Service Provider Software. The Service Provider Software may maintain a ledger of the user's gold balances in the different designated vault locations, and an ordered sequence of gold trades for each vault location. The data that characterize the trades can include: the user identity, the vault location the, type (buy/sell), the date and time of each transaction, amount of gold per transaction, the price of gold and exchange rate, the reference to the action that triggered the trade, the status (pending/settled), the balance in the account, and the balance in the vault after settlement.

To determine the gold price, the Service Provider Software can maintain a XAU/USD orderbook with bids/asks for each physical vault location. The Service Provider Software can be connected via FIX protocol to a trade engine, for example the ScotiaBank trade engine, which can receive real-time quotation feeds. During non-operational hours (e.g. Friday at 5:01 pm EST to Sunday at 6:29 pm EST) the Service Provider can populate the order book (e.g., without actually purchasing gold such as to queue up purchased for the next business day). The applied gold exchange rate can be guaranteed to be within 1% of the spot gold price, for example.

The settlement logic can be based on the gold effectively delivered and stored in the designated vaults. For example, real orders may be multiple of 1 kilogram, while user trades may be as small as 0.01 grams, so the agent can consider a trade (and all previous trades in the same vault location) settled if and only if the actual gold balance in the vault is sufficient to cover the “vault's balance after settlement” field of the trade and does not exceed it by more than 1 kg. If the service provider has significantly more gold or less gold, then the trades may remain in a pending state. At that point the Vault Operator may have to perform a real buy/sell order to settle the pending trades and the operator can choose the best time to perform the trade. Only once the Service Provider receives an updated balance from the Vault Operator can the pending trades be settled.

Events that can trigger the Service Provider Software trades can include deposits, withdrawals or redemptions, and transfers between users. A deposit can be identified by type (it may be a bitcoin payment, a credit card payment, interac, wire transfer, etc.) and related reference identification, the user that has performed the transaction, the selected vault location, and the settled fiat amount. Every deposit method at the end converts (if necessary) the origin currency in fiat currency (USD/CAD/EUR/ . . . ). Usually the user select vault location, currency/amount and payment method and then he is redirected to the specific instructions to perform it. We finally get the confirmation of the payment and with the received amount we insert a gold trade for the user (i.e. a database entry with the fields listed above). The exchange rate may be fixed at invoice creation time for on-line payments (cc, bitcoin, Interac) or when the payment is received (wire transfer).

A withdrawal should be very similar (it may be a bitcoin payment, a credit card refund, a debit card load, a wire transfer, etc.), the inputs are the same (vault location, currency/amount and method) but the agent and/or Service Provider Software can insert a gold trade to sell the amount required to satisfy user request. Transfers between users may be limited to only between gold in the same vault location. A transfer may be equivalent to a sell trade followed immediately by a buy trade, but the Service Provider may not charge fees for this operation, e.g., the exchange rate may be exactly the gold spot price. The settlement rules apply, but there may be a higher probability that the transfer will be immediately settled, because the final vault balance may not be required to change.

### EXAMPLES

Specific embodiments may be made by reference to the following examples:

### Example 1

### Terms of Service

Various embodiments apply to the use of: (a) a Service Provider website located at ServiceProviderURL.com, the Service Provider or Service Provider Software Application Programming Interface (“API”), and any associated Service Provider-hosted websites or mobile applications (collectively the “Service Provider Site”), and (b) any of the services provided to the user by Service Provider (together with the Service Provider Site, the “Service Provider Services”), including any client-hosted virtual currency wallet service (“Service Provider Wallet”).

The amount in a Service Provider account is not a deposit with the Service Provider. The Service Provider account is not a bank account. There is no interest payable on any amount in a Service Provider account. The amount in a Service Provider account is not insured by the Canada Deposit Insurance Corporation, the Federal Deposit Insurance Corporation, or any other governmental insurance.

Service Provider Services do not constitute a trading of, or an exchange in, securities, investment contracts or any document, instrument or writing commonly known as a “security”, at law or otherwise.

A person may only purchase or sell gold through a corresponding Service Provider account by way of (i) transfers to, or from, a personal bank account or virtual currency wallet in a name which has been linked to a Service Provider account, physical withdrawals of gold or, transactions with merchants through the use of a Service Provider debit card.

To be eligible to use the Service Provider Services, a user must be at least 18 years old (or the applicable age of majority and contractual capacity if the user resides in a jurisdiction where the age of majority or contractual capacity is above 18 years of age. By accessing or using the Service Provider Services the user represents and warrants that he or she is at least of the applicable age of majority and contractual capacity in the jurisdiction in which user resides.

### Communications

Communications between the user and the Service Provider may be conducted by mail or by telephone, fax, online, or by other electronic means. Any instructions that the user gives to us in any such manner will have the same legal effect as if the user gave instructions to us in original written form. The user agrees that all telephone calls and electronic communication may be recorded and kept by the Service Provider as a record of instructions.

The user is responsible for the accuracy of the instructions for all electronic transactions. Depending on the type of electronic transaction, instructions, once sent, may be final and irrevocable, so that it may not be possible to retrieve funds sent in error. It is the responsibility of the user to ensure that the personal information registered on the system is accurate at all times.

It is important that the user promptly reviews the transaction history and any account statements that the user receives to ensure that the Service Provider has properly acted on the instructions and that there have been no unauthorized dealings with the account. The user must inform us of any errors or omissions within 60 days of the disputed transaction(s).

### Security and Privacy

The user will be required to provide a copy of a government-issued photo identification and/or such other identifying and verifying information as the Service Provider determines from time to time in our discretion (the “ID Documentation”) prior to opening an account and thereafter at our discretion. The Service Provider will verify the ID Documentation and perform a background check prior to approving the application to open an account. The user consents to the Service Provider contacting credit bureaus to obtain information about the user for purposes of confirming the identity under applicable “know-your-client” rules. The user understands that failure to provide any of the information requested from time to time under such rules may result in the account being frozen and/or terminated without further notice.

To protect the privacy of the user and information about the account, when an account is opened the user must select a password. Unless the user provides the correct password, the Service Provider cannot follow instructions regarding the account. If the password is forgotten, the Service Provider may accept a combination of alternative pieces of personal identification information to grant access.

The Service Provider does not store user passwords, only their hashed representation. The Service Provider may charge a fee of not more than $25 to reset the password if the user forgets or loses the password.

Private/sensitive data (such as the bitcoin private key) is stored encrypted on the server-side with encryption techniques. Encryption/decryption of such data is performed on the client-side using a key derived from the user password.

Every network communication with the Service Provider servers is secured by the Transport Layer Security (TLS) protocol.

### Service Provider Debit Card

Once the Service Provider account has been approved, the user can complete an application to obtain a Service Provider debit card linked to the Service Provider account. If the application is approved, the user will be issued a Service Provider Debit Card by a third-party banking partner. The Service Provider Debit Card will allow access to the gold in the Service Provider account to complete purchases with the Service Provider Debit Card. The gold in the account will be converted into the applicable currency or digital currency designated under the Service Provider Debit Card for purchases no later than the 24 hours after the transaction is posted to the Service Provider account at a conversion rate that reflects the conversion rate shown in the live quote available at “www.ServiceProviderURL.com.”

In addition to the terms set out in the Agreement, the Service Provider Debit Card will also be subject to the terms and conditions set out in the Cardholder Agreement between the user and our third-party banking partner.

### Service Provider Wallet

The Service Provider Wallet provides a transmission service to and from external digital value networks such as Bitcoin, Ripple, or API's for third party applications. The Service Provider Wallet is a client-hosted wallet and is hosted by the user and not by the Service Provider. The Service Provider Wallet can only be used to complete transactions to and from the verified account at an external digital value network such as Bitcoin, Ripple, or other API for third party applications, or transactions with merchants through the use of the Service Provider Debit Card.

The Service Provider Wallet does not send or receive money. As a client-hosted virtual currency wallet, it transmits to and from the external networks information. This information can include bitcoin blocks that are associated with a public cryptographic key commonly referred to as a bitcoin address. By using the Service Provider Services, the user can inform these networks that the user is transferring bitcoin previously associated with the bitcoin account to another bitcoin account. Once the network recognizes the information sent from the Service Provider Services and validates it, the bitcoin network distributes the information to other individuals and companies in the network. The Service Provider Services cannot be used to cancel or reverse bitcoin-to-bitcoin transactions, as long as they are accepted and confirmed on the bitcoin network.

The Service Provider Wallet can be used by to view or transact in intangible virtual currency assets such as bitcoin. Such virtual currencies exist only by virtue of the ownership record maintained in their respective decentralized networks. Any transfer of title in bitcoins occurs within the decentralized Bitcoin network and not within the Service Provider Wallet.

The Service Provider Services utilize bitcoin accounts only to provide the functionality of a client-hosted bitcoin wallet. The Service Provider cannot make transactions using the bitcoin accounts except in conjunction with a request or command though use of the Service Provider Services.

The Service Provider Services require three private cryptographic keys to be associated with each bitcoin account, and require two of these private keys to initiate a bitcoin “transfer”. The Service Provider controls only one of these private keys. Depending on the volume or value of the bitcoin transfer, the Service Provider may require to the user to use both private keys under the control to initiate the transfer.

All proposed Bitcoin transactions must be confirmed and recorded in the Bitcoin public ledger via the Bitcoin distributed consensus network (“Verification Network”), which is not owned, controlled or operated by the Service Provider. The Service Provider Services helps the user submit the Bitcoin transaction request for confirmation to the Verification Network. However, the Bitcoin network, including the Verification Network, is operated by a decentralized network of independent third parties. The Service Provider does not have control over the Bitcoin network, including the Verification Network, and therefore cannot and does not ensure that any transaction request submitted via the Service Provider Services will be confirmed via the Verification Network. The Service Provider Services may not be completed, or may be substantially delayed, by the Verification Network. When the user completes a transaction request via the Service Provider Services, the user authorizes the Service Provider to submit the transaction request to the Verification Network in accordance with the instructions provided via the Service Provider Services.

### Fees and Limits

The price for any purchase or redemption of gold for any Service Provider transaction will be based on the Best Bid or Offer (BBO) in each respective vault location as reflected by the Service Provider Software pricing engine. The Service Provider Software engine collects and distributes real-time gold prices from bullion counterparties quoting bids and offers for the purchase or sale of physical gold bullion at each respective vaulting location where the Service Provider maintains a Vault. These prices are reflected on the Service Provider website. Every gold transaction in the Service Provider account is executed at the BBO plus an additional one percent (1%) fee. The Service Provider provides a price guarantee for any transactions executed from Sunday from 6:30 PM EST to Friday at 5:00 PM EST. This price guarantee maintains that the fee added to the BBO will be one percent (1%) or less. Given that gold trades on a 24/5 schedule, the Service Provider can only provide a price guarantee during those days. For transactions occurring from Friday at 5:01 PM EST to Sunday at 6:29 PM, the Service Provider Software prices will reflect the internal liquidity provided by the Service Provider market making operations.

The Service Provider earns a fee on every gold transaction. This fee is embedded into the official gold price distributed to the platform and website from the Service Provider Software. This fee is calculated by adding a one percent (1%) to the real-time BBO in each location as quoted by counter-parties in the Service Provider Software Pricing Engine. The Service Provider earns with an upper limit of 1% from Sunday 6:30 PM EST to Friday at 5:00 PM EST. During weekends and holidays when a BBO quotation from counterparties is not available, the fee the Service Provider earns on transactions may be higher or lower than 1% depending on its internal order management and desired risk exposure.

The Service Provider may charge a fee of not more than $25 to reset the password if forgotten or lost.

Physical redemptions are subject to a $25 processing fee payable from the redeeming account. Requested transactions may not be processed if you do not have sufficient funds.

### Gold Quality, Purity, and Auditing

The Service Provider takes only assayed bullion bars as good delivery from recognized counterparties, bullion-dealers, and bullion-banks according to best industry-practices, which exist on the market.

Any physical gold purchased by the user remains in the location that is selected when initiating the transaction.

The Service Provider deals exclusively in investment gold bullion being not less than 99.95% purity and of a weight and manufacturer accepted by the global bullion markets such as LBMA, COMEX or other globally recognized bullion markets.

The Service Provider accounting units of gold, in line with standard bullion-market practice, are expressed in fine gold content. The fine gold content of each bar is its weight multiplied by its purity. The resulting units of gold applied on the Service Provider account are 100% pure gold and denominated in kilograms and grams.

The Service Provider confirms that it has obtained a representation from its gold bullion counterparties that every gram of gold purchased by the Service Provider for the Service Provider accounts is a gram of the 100% pure gold content (fine gold) of a 99.95% (or greater) assayed bullion bar held in the relevant vault.

### Gold Storage

The user authorizes the Service Provider to arrange for the storage, transportation and insurance of the gold. The Service Provider will hold the gold as bailee on behalf of the user, pursuant to a storage agreement between the Service Provider and a Storage Vault such as Brink's Canada Limited, or any other gold vault operator selected by the Service Provider in its discretion (a “Vault Operator”).

All storage agreements with Vault Operators are entered into by the Service Provider, a wholly owned subsidiary of the Service Provider that operates as a segregated entity for the purpose of dealing with customer deposits and withdrawals of gold or currency.

Any storage agreement entered into with a Vault Operator provides that allocated gold will be specifically identified, and physically segregated at all times.

The Service Provider pays the fees to cover the costs of storage and insurance for the gold for so long as the user remains a customer of the Service Provider. The user authorizes the Service Provider to act as bailee on behalf of the user and to provide instructions to the Vault Operator and insurance company in such capacity.

### Bailment

A “bailment” occurs when a person (the “bailor”) delivers personal property into the possession of another person (the “bailee”) for safekeeping but retains legal title to the property. The bailee (the person who has possession of the goods) holds possession of the property on the understanding that the property will be returned to the bailor (the user) once the bailment relationship is terminated according to the bailor's (the user's) instructions.

In the case of the Service Provider account, the gold in the account is held by the Service Provider as bailee, which means that the user retains legal title to the gold but that the user has asked the Service Provider to maintain possession of the gold on behalf of the user until such time as the gold is redeemed.

### Insurance

The Service Provider ensures the bullion is insured against theft and damage according to the accepted insurance standards of the bullion industry, and at a cost which is included in the charge paid to the Service Provider in respect of custody of the bullion.

The Service Provider confirms to you that, in each storage agreement, the Vault Operator agrees to provide the Service Provider with documentary evidence of insurance.

### Redeeming Gold

The user may, by initiating a redemption request via the Service Provider platform together with such identifying information as requested by the Service Provider and on behalf of the Vault Operator, at any time request physical redemption of the gold, provided that the user holds sufficient gold and subject to the withdrawal limits described below. The user is responsible for any insurance, delivery, and transportation fees.

Physical withdrawals of gold are subject to a minimum quantity in the form of whole numbers of 1 KG 0.9995 or better Gold Bars, LBMA Good Delivery Bars, or 10 g BitGold Cubes® 0.9999+ Fine Gold to be pre-selected when making a physical withdrawal request through the Service Provider platform. Physical withdrawals of bars or cubes, are not and will never be subject to withdrawal limits.

Additionally and/or alternatively, the user can also convert gold from the account by using the Service Provider Debit Card or by transferring funds to the personal bank account or virtual currency wallet of the user. The gold in the account will be converted to the applicable currency at the time of the withdrawal. The Service Provider Debit Card conversions may be subject to spending limits based on the gold balance and maximum daily allowance that is prescribed by the third-party banking operator. Gold conversions to and from the bank account are not subject to any transaction limits. However, the Service Provider does not allow for third-party wire transfers.

Gold redemptions from the Service Provider Vault to the Service Provider Wallet require a 2-4 business-day time-window for processing following multi-factor authentication of the redemption request and are limited to 5% of the gold value in the account (based on the BBO gold price in each respective vault location as reflected by the Service Provider Software pricing engine) for each request. There is no minimum withdrawal quantity for Gold redemptions from the Service Provider Vault to the Service Provider Wallet. The maximum limit is there to help protect the account from potential misuse. Traditional Gold redemptions require a 2-3 business-day time-window for processing.

### Promotional Balances

Every verified Service Provider account holder automatically receives 1 gram of gold into the Service Provider Vault account. In addition, for every subsequent referral made by an existing Service Provider account holder (using the unique referral link provided by the Service Provider through its affiliate program which can be found here: www.ServiceProvider.com/affiliates), a verified Service Provider account holder will receive an additional deposit of 0.5 grams of gold into their Service Provider Vault. These deposits are made by the Service Provider by transferring gold that has been previously acquired by the Service Provider into the verified account holder's account. These deposits are promotional balances (“Promotional Balances”) and are subject to the terms of this Agreement.

Promotional Balances are equal in value and redemption rights to traditional Service Provider balances as long as the recipient of the Promotional Balance has logged into their Service Provider account at least once over a 60 day period. If the recipient has not logged into their account for a period exceeding 60 days, and no external deposits of funds has been made into the account during such period, the Service Provider may, at the Service Provider's discretion, reclaim the Promotional Balances to the Service Provider's own resources as an unclaimed promotion.

The Service Provider reserves the right to suspend, modify or terminate a promotion at any time and without prior notice.

### Ownership Records

The Service Provider maintains the master copy of ownership records. Records relating to the user and the account will only be modified upon the execution of valid instructions, in accordance with the terms of this Customer Agreement.

On a regular and frequent basis, but no more frequently than daily, the Service Provider will publish to internal as well as independent external sources reconciled and aliased customer-by-customer records of ownership of all the bullion in the vaults held by customers.

The Service Provider makes available current balances at “www.ServiceProviderURL.com/transparency”.

The Service Provider ensures that at least two widely separated data storage sites receive duplicates of the full Service Provider database.

Every day the Service Provider sends an encrypted, electronic copy of all clients' identities, aliases and their balances both to its auditors and to a Vault Operator. Neither an auditor nor a vault operator can interpret or use this data without the decryption key.

### Taxes

The user is responsible for paying all local taxes and tariffs that are or may be applicable to purchases, conversion, sale or custody of gold, and any associated charges.

The Service Provider application will provide the user with a tax tool for calculating yearly gains or losses from the purchases, sales, and spending transactions that have occurred within the account. This tax tool is provided as a service only and is not intended to be, nor should it be relied upon as legal or tax advice.

### Currency

Any and all monetary amounts displayed in the Service Provider website are in the local currency selected by you.

### Example 2

### Service Provider Sign Up

The service provider accounts are free and can be opened by anyone, anywhere in just a few minutes. The process includes 4 steps, which are displayed below:

Step 1—Verify by Email

a) Once on the www.ServiceProviderURL.com landing page, select the “Sign In” button.

b) Fill out the required email and password fields. Once complete, read over the Service Provider Terms and Conditions and select the toggle to acknowledge you have done so. Then click “Create Account.”

c) A verification email will be sent to an inbox of the user. If the user does not receive the email within 5 minutes, please check the “SPAM” folder. If it has not arrived, click the “Re-Send Email” link.

d) Click the “Finish Signing Up” button on the verification email sent.

Step 2—Verify the Account Using a Mobile Phone

a) The next step involves verifying the account with a 4-digit code sent via SMS text message to a mobile device. To initiate this action, enter your mobile number in the required field and click “Send Code”.

b) Once you receive the code, type that number in the text box and click “Verify Mobile”. If you didn't receive the SMS text, or input the wrong mobile number, click on the appropriate links on the bottom of the page. A new SMS text will be sent. *Please note, the code is valid for 5 minutes before expiring. An automated phone call is initiated after 2 minutes reminding users of the need to validate their account.

Step 3—Basic Profile Information+

Enter basic account information in the appropriate fields. Click on the “Continue” button once complete.

Step 4—Verify Identification

Uploading approved ID to the Service Provider platform can be done in 1 of 3 ways: file upload using drag-and-drop, webcam and email. Select the preferred method and follow the written instructions.

### Upload Identification

Every account holder is required to upload a government-issued ID and goes through an on-boarding process. The Service Provider accepts three standard forms of government-issued identification: Passport, Driver's License and National ID Card.

Uploading approved ID can be done in 1 of 3 ways:

Option 1—Upload a Scanned Copy of an ID Directly from a Computer.

Choose to drag and drop the ID from the computer into the upload box or click the “Browse” link. Choose the government-issued ID. Click the “Confirm” button when complete.

### Option 2—Use a Webcam

Click the “Use Webcam” button. Align the ID to the capture box and press the “Picture” icon. (Note: you may need to adjust webcam privacy settings to allow access to the Service Provider platform).

### Option 3—Send by Email

Click the “Send By Email” button. The user will receive a unique email address generated by our system. Copy the unique email address and paste into a new email. Attach the government-issued ID to the email and send it to the unique email address. Click “Click Here Once You've Sent the Email” when the email has been sent. The system will automatically check the email in real time, it will take between 30 seconds and 5 minutes. When the ID appears, check that it has uploaded correctly. Click the “Confirm” button to continue. Click “Cancel” to attempt the upload again.

### Gold Pricing

The Service Provider's gold will always be priced within 1% of the official spot price. Gold's ‘spot price’ is regarded as the explicit value of gold at any given time in the marketplace. We do this using our proprietary Service Provider Software Technology. In real-time the Service Provider Software obtains pricing feeds from precious metals dealers, bullion banks, and mining companies that quote bid/ask spreads in various vaults around the world.

### Purchasing Gold

The Service Provider accepts many secure payment options, some of which vary by region. Bank wire, MasterCard, Visa, Interac and China UnionPay are all accepted.

### Spending Gold

The Service Provider Debit Card allows the user to spend the vaulted gold at point of sale anywhere globally, online or where MasterCard is accepted. The user can also withdraw local currency from any ATM. The Service Provider users can also send payment for invoices directly to and from the Service Provider account.

### Transferring Gold

The gold in the Service Provider account can be sent to any other Service Provider accounts for free. The user can send gold to a non-Service Provider member via email where the non-Service Provider member will be prompted to quickly create a free account to receive the gold.

### Redeeming Gold

Service Provider users can choose to redeem their gold at any time. Redemptions can be done via Bank Wire, Credit Card, INTERAC, or Physical Gold. For physical gold redemptions, the user simply chooses the amount to redeem, in increments of either 10 g Cubes and/or 1 KG 0.9995 Bullion Bars. The user then has the option to either pick up the gold in-person or have it securely shipped directly to the user. Physical gold redemption fees are $25+any additional shipping, handling, and insurance. To get started with redemption simply login to the Service Provider account and click the “Redeem” button on the top right and follow the steps.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A method for converting cryptographic currency to vaulted physical gold, comprising:
establishing an authenticated network communication session with a user via data transmissions between a network server and a client device;
reading, from a non-transitory computer readable medium, a user account ledger first balance;
wherein the user account ledger includes a cryptographic currency portion and a vaulted gold portion;
outputting for display on a client device electronic display apparatus, a depiction of at least a portion of the user account ledger first balance;
receiving designation of a physical vault location from a plurality of physical vaults;
receiving, from the user via a graphical user interface displayed by the electronic display apparatus of the client device, a gold purchase order command to purchase vaulted gold in the designated vault with a selected cryptographic currency quantity forming at least a portion of the first balance of the cryptographic currency portion of the user account ledger;
writing, to the user account ledger, a pending transaction corresponding to the user command to purchase vaulted gold;
debiting, from the first balance of the cryptographic currency portion of the user account ledger, the selected cryptographic currency quantity to form a user account ledger second balance and crediting the cryptographic currency quantity to an agent ledger balance;
outputting, for display on the client computer electronic display apparatus, a depiction of the pending transaction and the user account ledger second balance;
purchasing the vaulted gold on behalf of the user according to a settlement process using the cryptographic currency quantity credited to the agent;
generating confirmation in an agent computer that the purchased gold has been transferred to the user account;
crediting the transferred vaulted gold to the vaulted gold portion of the user ledger balance to form a user account ledger third balance;
updating the pending transaction status to a settled status; and
outputting for display on the client computer electronic display apparatus a depiction of the settled transaction and the user account ledger third balance.

2. The method for converting cryptographic currency to vaulted physical gold of claim 1, wherein receiving designation of a physical vault location comprises receiving a physical vault selection from the user via a graphical user interface displayed by the electronic display apparatus of the client device.

3. The method for converting cryptographic currency to vaulted physical gold of claim 1, wherein receiving designation of a physical vault location comprises:
receiving a client device location from a client device location services module; and
designating a physical vault having a location corresponding to the client device location.

4. The method for converting cryptographic currency to vaulted physical gold of claim 1, wherein receiving designation of a physical vault location comprises:
reading a user residence location from a user profile carried by a non-transitory computer-readable medium; and
designating a physical vault having a location corresponding to the user residence location.

5. The method for converting cryptographic currency to vaulted physical gold of claim 1, wherein receiving designation of a physical vault location comprises:
reading metadata corresponding to a data transmission from the client device, the metadata including one or more network server identities through which the data transmission was relayed;
inferring a client device location from the network server identities; and
designating a physical vault having a location corresponding to the inferred client device location.

6. The method for converting cryptographic currency to vaulted physical gold of claim 1, wherein the settlement process comprises:
displaying the gold purchase order on an electronic display of an agent device; and
receiving, from the agent via a user interface of the agent device, an order to purchase the vaulted gold from a seller of the vaulted gold.

7. The method for converting cryptographic currency to vaulted physical gold of claim 1, wherein the settlement process is executed automatically by a computer executing computer executable instructions carried on a non-transitory computer readable medium.

8. The method for converting cryptographic currency to vaulted physical gold of claim 1, wherein the settlement process includes aggregating a plurality of user gold purchase orders.

9. The method for converting cryptographic currency to vaulted physical gold of claim 1, wherein the settlement process comprises:
aggregating a plurality of gold purchase order commands from a plurality of users to purchase vaulted gold in the designated vault;
determining when the aggregated gold purchase order commands correspond to a minimum gold purchase quantity at the designated vault;
causing a conversion of the corresponding aggregated cryptographic currency amounts into an aggregated amount of fiat currency;
causing a payment of the aggregated amount of fiat currency to a gold seller in return for aggregated gold purchase quantity at the designated vault; and
receiving confirmation from the designated vault that the aggregated purchased gold has been transferred from the gold seller.

10. The method for converting cryptographic currency to vaulted physical gold of claim 9, wherein generating confirmation that the purchased gold has been transferred to the user account includes apportioning the confirmed aggregated gold purchase confirmation to the user.

11. The method for converting cryptographic currency to vaulted physical gold of claim 9, wherein crediting the transferred vaulted gold to the vaulted gold portion of the user ledger balance includes crediting an apportioned amount of the transferred vaulted gold portion of the aggregated purchase corresponding to the vaulted gold portion of the user ledger balance.

12. The method for converting cryptographic currency to vaulted physical gold of claim 9, wherein the purchased gold corresponds to an integer number of gold units.

13. The method for converting cryptographic currency to vaulted physical gold of claim 12, further comprising:
adding to the aggregated amount of fiat currency an additional amount of fiat currency sufficient to cause purchase of the integer number of gold units.

14. The method for converting cryptographic currency to vaulted physical gold of claim 12, further comprising:
adding to the aggregated amount of cryptographic currency an additional amount of cryptographic currency sufficient to cause purchase of the integer number of gold units.

15. The method for converting cryptographic currency to vaulted physical gold of claim 12, further comprising:
adding to the aggregated amount of purchased gold, an additional amount of gold credits sufficient to cause purchase of the integer number of gold units.

16. The method for converting cryptographic currency to vaulted physical gold of claim 1, further comprising:
determining a gold price; and
outputting the gold price for display to the user on the client device.
